(19) United States
(12) Patent Application Publication
(10) Pub. No.: US 2024/0163808 A1
(43) Pub. Date: May 16, 2024

(54) METHODS OF POWER MANAGEMENT IN AN INTEGRATED ACCESS AND BACKHAUL NETWORK

(71) Applicants: Centre of Excellence in Wireless Technology, Tamil Nadu (IN); Indian Institute of Technology Madras (IIT Madras), Tamil Nadu (IN)

(72) Inventors: Deepak Agarwal, Tamil Nadu (IN); Priyanka Dey, Tamil Nadu (IN); Thirunageswaram Ramachandran Ramya, Tamil Nadu (IN); Abhijeet Abhimanyu Masal, Tamil Nadu (IN); Jeniston Deviraj Klutto Milleth, Tamil Nadu (IN); Bhaskar Ramamurthi, Tamil Nadu (IN)

(21) Appl. No.: 18/551,150

(22) PCT Filed: Mar. 16, 2022
(86) PCT No.: PCT/IN22/50252

§ 371 Date: Sep. 18, 2023

(30) Foreign Application Priority Data
Mar. 19, 2021 (IN) 202141011863

(51) Int. Cl. H04W 52/24; H04W 52/14

(52) U.S. Cl. CPC H04W 52/243; H04W 52/143; H04W 52/242

(57) ABSTRACT

A method of interference measurement for power management in an integrated access and backhaul (IAB) network. The method includes: requesting, by a Reference IAB node, configuration of a Downlink-Reference Signal (DL-RS) for measurement of interference, to one of: a Parent IAB node, by sending a trigger from a Mobile Termination (MT) of the Reference IAB node, and a Donor IAB node, by sending a request for instruction to the Parent IAB node for the configuration of the DL-RS, from a Distributed Unit (DU) of the Reference IAB node. The method also includes signaling, by the Parent IAB node, a configuration information of at least one of a periodic DL-RS, aperiodic DL-RS and semi-periodic DL-RS, to one of the MT of the Reference IAB node and DU of the Reference IAB node.

### FIELD OF THE INVENTION

The present invention relates to cellular wireless communication systems, and more particularly to power management in an integrated access and backhaul network of a cellular wireless communication system.

### BACKGROUND OF THE INVENTION

With the advent of fifth generation (5G) New Radio (NR) and an ever-increasing demand for high data rates, an enormous increase in backhaul capacity requirement is envisioned. Besides, to fulfil the needs of faster speeds, lower latencies and always-on connectivity, requirements of small cell densification, dynamic switching ON and OFF of small cells, and mobile backhaul are foreseen. The above mentioned needs from a wireless network can be fulfilled using a wireless channel with huge bandwidth for backhaul link. Thus, an Integrated Access and Backhaul (IAB) network using self-backhauling is necessitated.

FIG. 1 illustrate a typical Integrated Access and Backhaul (IAB) network, in accordance with prior art. The IAB network consists of a Donor node (102). The Donor node (102) is a primary node in the network connected to a core network. The Donor node (102) controls a plurality of IAB nodes (104(1)-104(n)) connected to the Donor node (102) in the IAB network. Each node of the plurality of IAB nodes (104(1)-104(n)) can further be connected to one or more Child IAB nodes, leading to a multi hop network. The IAB network may employ either a tree or a directed acyclic graph(DAG) architecture. In the IAB network, Access (AC) link (106) indicates a link between an IAB node and an AC User Equipment (UE) attached to the IAB node and a Backhaul (BH) link (108) indicates a link between a Parent IAB node and the Reference IAB node. Each IAB node consists of a mobile termination (MT) part and a distributed unit (DU) part. The MT of the IAB node connects to the Parent IAB node and is like a UE in functionality. The DU of the IAB node connects to one of the Child IAB nodes or AC UEs and is like a Base Station (BS/gNB) in functionality.

In an IAB network, same channel is used in BH and AC links. Therefore, resource multiplexing between the Parent BH link, Child BH link and Child AC link is a crucial task. Resource multiplexing may be done in one of time, frequency, and space domain, leading to one of a time division multiplexing (TDM), frequency division multiplexing (FDM) and Space division multiplexing (SDM) schemes, respectively. In FDM and SDM schemes, the BH and AC transmissions or BH and AC receptions exist simultaneously. IAB nodes with FDM and SDM capability with half duplex constraints can operate in either simultaneous transmission mode or simultaneous reception mode. In case of FDM, interference between downlink (DL) transmissions or receptions and uplink (UL) transmissions or receptions will occur due to adjacent channel leakage. In case of SDM, interference between DL transmissions or receptions and UL transmissions or receptions will occur due to inter beam interference. In a TDM scenario, the Reference IAB node transmits in the BH-UL (to its Parent IAB node) and AC-DL (to its Child IAB node or AC UE) in different time slots. The BH efficiency may be improved by increasing the UL transmission power of the MT of the Reference IAB node beyond the desired UL power set by conventional UL power control. The increment in the UL transmit power may be upto the maximum transmit power capability of the Reference IAB node. However, sudden increment of UL transmission power upto the maximum limit may cause interference in other ongoing transmission in a network. Thus, there is a need for power management for interference mitigation and improving BH efficiency in FDM, SDM and TDM.

Consider a multi-hop IAB network with a Reference IAB node, having a Parent IAB node and one of Child IAB nodes and AC UEs. In simultaneous reception scenario, the Reference IAB node receives in both the BH and one of Child BH and AC link simultaneously. Simply put, there is DL reception from the Parent IAB node and UL reception from one of the Child IAB node and AC UE. The UL transmission from the Child IAB node or AC UE is under power control by the DU of the Reference IAB node and hence, the UL power from the Child IAB node, received at the Reference IAB node may be less than the DL power received from the Parent IAB node causing power imbalance in simultaneous reception. Therefore, the DL power from the Parent IAB node creates interference to the UL reception from the Child IAB node at the DU of the Reference IAB node, both in FDM and SDM scenario. In SDM, if the beams are overlapping, it causes inter beam interference. Inter beam interference is especially more severe in IAB nodes with single panel. The basic method to avoid interference is to choose beams that are far apart, so that the effect of interference is negligible. However, due to limitations in analog beam forming and relative position of the Parent IAB node and one of the Child IAB node and AC UE, it may be desired to choose beams that are overlapping in certain situations. In such cases, the interference from DL will affect the UL reception. Therefore, power control for DL transmission from IAB node is crucial.

In a simultaneous transmission scenario, the Reference IAB node simultaneously transmits in both the BH-UL to the Parent IAB node and AC-DL to the Child IAB node. For IAB nodes with multiple panels, there are different radio frequency (RF) Chains for transmissions in BH and AC links, hence no power sharing is required between transmissions from different panels. However, power sharing is crucial for IAB nodes with single panel, as there is a constraint on the maximum power. Since a power amplifier is shared between the MT of the Reference IAB node and DU of the Reference IAB node, there is further a need for a balanced power sharing between the MT and the DU part of the Reference IAB node.

Thus, there remains a need to manage and control power in an IAB network to improve overall performance of the network.

### OBJECTS OF THE INVENTION

A general objective of the present invention is to provide methods of power management including power control methods for interference mitigation and BH efficiency as well as power sharing in IAB network.

Another objective of the invention is to mitigate transmission power imbalance in simultaneous receptions.

Still another objective of the present invention is to split power between BH and AC links in a manner to ensure successful transmission in BH and AC links satisfying maximum power limit but also to mitigate transmission power imbalance in simultaneous transmissions, if any, by limiting the maximum power per link.

Yet another objective of the present invention is to reduce DL power to enable power saving at the IAB nodes, making the technology sustainable.

### SUMMARY OF THE INVENTION

The present invention relates to a method of power management in an integrated access and backhaul link.

The present invention relates to a method of interference measurement for power management in an integrated access and backhaul (IAB) network. The method may comprise requesting by a Reference IAB node for configuration of a Downlink-Reference Signal (DL-RS) for measurement of interference. The request may be made to one of a Parent IAB node, by sending a trigger from a Mobile Termination (MT) of the Reference IAB node, and a Donor IAB node, by sending a request for instruction to the Parent IAB node for the configuration of the DL-RS, from a Distributed Unit (DU) of the Reference IAB node. The Parent IAB node may signal a configuration information of at least one of a periodic DL-RS, aperiodic DL-RS and semi-periodic DL-RS to one of the MT of the Reference IAB node and DU of the Reference IAB node. The MT of the Reference IAB node may share the configuration information of the DL-RS with the DU of the Reference IAB node, when the configuration information is provided to the MT of the Reference IAB by the Parent IAB node. The DU of the Reference IAB node may receive a signal at a location of the DL-RS on an Uplink (UL) reception beam. The DU of the Reference IAB node may measure interference in time-frequency resources where the DL-RS is scheduled.

In one aspect, the trigger may have a length of at least one bit.

In one aspect, the measurement of interference may include at least one of a Reference Signal Receive Power (RSRP), Received Signal Strength Indicator (RSSI), and Reference Signal Received Quality (RSRQ).

In one aspect, the configuration information of the DL-RS may include at least one of a time location of RS and frequency location of RS, RS sequence, RS precoder, and RS transmit power.

In one aspect, no transmission in the UL may be scheduled by the Reference IAB node for the Child IAB node in the time-frequency resources where DL-RS is scheduled, to enable accurate measurement of the interference.

In another aspect, one of a Mobile Termination (MT) of a Reference IAB node and a Distributed Unit (DU) of the Reference IAB node may request a Parent IAB node, for configuration of a Downlink (DL) signal and a DL signal transmission power, for measurement of pathloss, and a Donor IAB node, for instructing a Parent IAB node for configuration of a DL signal and a DL signal transmission power for measurement of pathloss. The Parent IAB node may signal a configuration information of the DL signal for the measurement of pathloss. The Reference IAB node may receive the configuration information of the DL signal. The Reference IAB node may estimate a pathloss between a DL transmission beam of the DU of the Parent IAB node and an Uplink (UL) reception beam of the DU of the Reference IAB node, based on DL signal transmit power information available at the Reference IAB node. The Reference IAB node may measure a gain of the UL reception beam at the DU of the Reference IAB node in the direction of a Downlink (DL) beam of the Parent IAB node. The Reference IAB node may determine a threshold value of receiver gain of UL reception beam based on at least one of a maximum tolerable interference power, measured pathloss, and DL transmission power from the Parent IAB node. A comparison of a value of measured gain with a threshold gain of UL reception beam may be utilized for determining level of interference caused by DL reception from the Parent IAB node on the UL reception from the Child IAB node.

In one aspect, the DL signal may be one of a Downlink Reference Signal (DL-RS), Synchronization Signal Block (SSB), DL data channel, or control channel.

In one aspect, the configuration information may include at least one of a time locations, frequency locations, RS sequence, RS transmit power, channel content and channel average power.

In one aspect, estimation of pathloss may be done by one of the MT of the Reference IAB node for intra panel scenario and the DU of the Reference IAB node for inter panel scenario.

In one aspect, the direction of the DL beam of the Parent IAB node may be provided by the MT of the Reference IAB node to the DU of the Reference IAB node.

In one aspect, the maximum tolerable interference power at the DU of the Reference IAB node may be derived using UL target received power of the access link.

In one aspect, the value of measured gain greater than the threshold gain of the UL reception beam may indicate significant interference in the UL reception beam and the value of measured gain less than the threshold gain of the UL reception beam may indicate negligible interference in the UL reception beam.

In another aspect, a Reference IAB node may send a power ratios authentication request in one of Uplink Control Information (UCI) and Uplink (UL) data, to a Parent IAB node. The Parent IAB node may signal at least one of start time of simultaneous operation in Backhaul (BH) link in Downlink (DL) and Access (AC) link in UL of the Reference IAB node, by one of a Donor node and a Mobile Termination (MT) of the Reference IAB node, and a number of symbols (N) present between a symbol where authentication request is sent and a first symbol of simultaneous operation by the Reference IAB node. The Parent IAB node may determine if there is a change in power of at least one of a first Downlink (DL) signal, a first DL channel, and associated power ratios at a Distributed Unit (DU) of the Parent IAB node which causes a corresponding change in power of one of current and upcoming channels linked to at least one of the first DL signal and the first DL channel. The Parent IAB node may perform one of sending an authentication indicator to the MT of the Reference IAB node, if the same power ratios will be used for the DL transmissions at DU of the Parent IAB node, and informing value of new power ratios to the MT of the Reference IAB node, if there is a change in the power ratios of DL transmissions at DU of the Parent IAB node. The Reference IAB node may measure interference caused by BH-DL reception of at least one of the DL signal, and the DL channel at AC-UL reception using power ratios and at least one of power of Channel State Information Reference Signal (CSI-RS) and power of Synchronization Signal Block (SSB) configured to the MT of the Reference IAB node.

In one aspect, the power ratios may include ratio of power of at least one of DL data, DL control, DL signal, and channel power to one of the CSI-RS and the SSB.

In one aspect, the new power ratios may be shared through at least one of Radio Resource Control (RRC), Medium Access Control-Control Element (MAC-CE), and Downlink Control Information (DCI).

In one aspect, the value of the number of symbols (N) may range between a maximum and a minimum value. The maximum value may be a duration between the last symbol of downlink control information transmitted at a DU of the Reference IAB node for scheduling UL transmission at the MT of the Child IAB node and the start time of simultaneous operation at the Reference IAB node. The minimum value may be processing time required by the Reference IAB node for the simultaneous operation.

In one aspect, the processing time required by the Reference IAB node may be based on at least one of MT Physical Downlink Control Channel (PDCCH) decoding, Physical Data Shared Channel (PDSCH) reception preparation time, and DU scheduling time for the Child IAB node.

In another aspect, a Reference IAB node may measure an interference power using at least one of a Downlink Reference Signal (DL-RS), Synchronization Signal Block (SSB), Downlink (DL) data channel, and control channel, from Parent IAB node. The Reference IAB node may report an assistant information of resources where interference occurred, to one of the Parent IAB node and a Donor node. The Parent IAB node may perform DL power control in the reported resources.

In one aspect, when the interference is measured, the Reference IAB node may calculate a Signal to Interference and Noise Ratio (SINR) and may derive a corresponding value of at least one of Channel Quality Indicator (CQI) and Modulation and Coding Scheme (MCS).

In one aspect, the assistant information of resources may be reported when at least one of a calculated value of the CQI is less than a target CQI value and the interference from a DL beam from the Parent IAB node is significant at Reference IAB node.

In one aspect, the DL power control may be performed by a Distributed Unit (DU) of the Reference IAB node. The DU of the Reference IAB node may inform an interference power to the Mobile Termination (MT) of the Reference IAB node. The MT of the Reference IAB node may signal an indication of increase in the interference to the Parent IAB node. The DU of the Reference IAB node may also inform an indication of increase in interference, to the Donor IAB node. The Donor IAB node may request to configure DL power reduction at the Parent IAB node.

In one aspect, the Parent IAB node may receive a signal for the DL power control, from any one of the MT of the Reference IAB node, by including an additional indication of increase in interference in UL, the Donor IAB node, and the DU of the Reference IAB node, through at least one of a new signal and channel.

In one aspect, the Parent IAB node may check for a change in beam pair. The Parent IAB node may perform one of a modification in DL power based on the increase in interference when there is no change in beam pair, and calculation of new DL power for a newly latched beam pair, when there is a change in beam pair. The Parent IAB node may indicate newly latched beam pair index to the Reference IAB node through at least one of a Downlink Control Information (DCI) and Medium Access Control-Control Element (MAC-CE) signalling.

In one aspect, the signalling may be performed using at least one of physical layer signalling, MAC-CE signalling, and RRC signalling.

In another aspect, a Parent IAB node may configure a Reference IAB node with Downlink Reference Signal (DL-RS) for interference measurement and to feedback value of Downlink (DL) channel quality. The Parent IAB node may receive at least one of an indication of interference and the value of DL channel quality. The Parent IAB node may compare the value of DL channel quality with a target DL channel quality value. The Parent IAB node may assess fulfilment of the request for DL power reduction, wherein if the reported DL channel quality is lower than the target DL channel quality value, the request for DL power reduction cannot be fulfilled and the Reference IAB node switches to Time Domain Multiplexing (TDM) mode. When the reported DL channel quality is higher than the target DL channel quality, the Parent IAB node may perform one of reduction of the DL power for a time duration, performing link adaptations techniques for reduction of DL power, and indicating, by the Parent IAB node, a command for adjustment of received beam gain of the Uplink (UL) reception beam in a direction of the Parent IAB node to the Reference IAB node.

In one aspect, the assessment of fulfilment of the request for DL power reduction may include assessment of a target Downlink Modulation and Coding Scheme (DL-MCS) being not affected by the reduction in DL power and a power of at least one of Synchronization Signal Block (SSB) and Channel State Information Reference Signal (CSI-RS) not being compromised.

In one aspect, the link adaptation techniques may include at least one of reducing Modulation and Coding Scheme (MCS), and reducing number of spatial layers.

In one aspect, the Parent IAB node may indicate an adapted change for reduction of the DL power for the time duration to the Reference IAB node through one of downlink control information (DCI) and MAC-CE signalling.

In one aspect, the Parent IAB node may monitor for expiration of a timer associated with an allotted time duration with reduced DL power, and upon expiry of the timer and using at least one of a conventional DL power defined for New Radio (NR) systems, and a last updated DL power, based on an indication received from the Reference IAB node within the timer duration to use the last modified DL power.

In one aspect, the Parent IAB node may wait for a next DL power reduction request until expiry of the timer, and using modified DL power after assessment of the request for a further DL power reduction.

In another aspect, a Reference IAB node may detect interference caused by the Downlink (DL) reception from a Parent IAB node on Uplink (UL) reception from at least one of a Child IAB node and an access link in any one of Frequency Division Multiplexing (FDM) and Space Division Multiplexing (SDM) modes. The Reference IAB node may send a request for reduction in DL power by an offset to the Parent IAB node. The Parent IAB node may decrease, the DL power based on the request for DL power reduction. The Parent IAB node may acknowledge by indicating the reduction in DL power to the Reference IAB node for the request for reduction in DL power.

In one aspect, the request for reduction in DL power may be in the form of a TPC request. The TPC request may be one of existing format of TPC offset values described in New Radio (NR) for UL, one bit indication, a new offset value and a range of TPC values with a number of levels.

In one aspect, the Parent IAB node may determine a range of negative TPC values starting from zero to a negative minimum value depending on a target MCS and minimum transmit power of the DU of the Parent IAB node with a defined step size.

In one aspect, the decrement in DL power by the Parent IAB node may be in form of a defined step size within the range of negative TPC values and may be decreased until a last value of TPC in the range is reached.

In one aspect, the Parent IAB node may monitor a timer for expiration of a time duration after receiving the TPC request for the decrement in DL power.

In one aspect, the Parent IAB node may use one of a conventional DL power as defined for New Radio (NR) systems, and a modified DL power based on the received TPC request, when an indication from the Reference IAB node to use the modified DL power may be received within the timer duration, when the timer expires.

In one aspect, the Parent IAB node may wait for next TPC request, until expiry of the timer.

In one aspect, the request for DL power reduction may be sent using at least one of User Control Information (UCI) signalling, Medium Access Control (MAC) signalling, and along with Uplink (UL) data.

In another aspect, a Reference IAB node may detect an interference occurring in resources used for Uplink (UL) reception in access link by adjacent resources used for the BH-DL reception when the Reference IAB node uses Frequency Division Multiplexing (FDM) for the reception. The Parent IAB node may receive one of a request for reduction in DL power and associated resources from the Reference IAB node and instruction by the Donor IAB node for the reduction in DL power and associated resources. The Parent IAB node may reduce a DL transmission power to the received resources.

In one aspect, the resources for the request of reduction in DL power may be edge Resource Blocks (RBs) of bandwidth part allocated to an MT of the Reference IAB node, wherein with the reduction in DL power by the Parent IAB node, the interference at adjacent Uplink (UL) reception at DU of Reference IAB node is minimized and the edge RBs are utilized.

In one aspect, the MT of the Reference IAB node may send the request for reduction in power of associated resources by including one bit signal in any of an Uplink control information (UCI) and Medium Access Control (MAC).

In one aspect, the Parent IAB node may reduce the DL transmission power for the edge RBs by using at least one of transmitting power equal to half of power in center RBs, transmitting power equal to UL power of adjacent RBs used for reception from access link at the DU of the Reference IAB node, transmitting less power consuming signals in the edge RBs, power control in the edge RBs utilizing a decrement in power offset received from the Reference IAB node in User Control Information (UCI) and minimum power required for at least one of Synchronisation Signal Block (SSB) and Channel Status Information Reference Signal (CSI-RS).

In another aspect, a Parent IAB node may determine an initial minimum Downlink (DL) target power. The Parent IAB node may configure and trigger the resources for measurement and feedback of information of pathloss and a link quality. The Reference IAB node may report a parameter indicating a Downlink Pathloss and the link quality measurement, to the Parent IAB node. The Parent IAB node may determine a DL transmission power of the link to the Reference IAB node based on at least one of the parameter indicating the Downlink Pathloss, the link quality measurement, and minimum Downlink (DL) target power.

In one aspect, the initial minimum Downlink (DL) target power may be equal to an uplink (UL) target power scaled with an offset, wherein the offset may be dependent on at least modulation and coding scheme (MCS) used by the Parent IAB node.

In one aspect, the DL transmission power of the link to the Reference IAB node may be determined by adding at least one of a value of the Downlink Pathloss and an offset determined by the Parent IAB node based on the received link quality measurement report to the minimum DL target power.

In one aspect, the parameter may indicate the Downlink Pathloss and link quality measurement signalling may be reported using at least one of physical layer signalling, Medium Access Control-Control Element (MAC-CE) signalling, and Radio Resource Control (RRC) signalling.

In another aspect, a Reference IAB node may transmit an indication of requirement of increase in Backhaul Uplink (BH-UL) power beyond desired UL power decided by UL power control parameters, to a Parent IAB node. The Parent IAB node may send Transmit Power Control (TPC) commands with increased step size for the BH-UL from the Reference IAB node to reduce the number of TPC signalling for increase in UL transmit power. The Parent IAB node may signal an initial threshold UL transmit power to the Reference IAB node. The Reference IAB node may monitor receipt of the TPC command. The Reference IAB node may increase the UL transmit power with the defined step size upon receiving every TPC command, when the UL transmit power is less than the threshold UL power.

In one aspect, the Reference IAB node may transmit with power equal to previous UL transmission power to the parent IAB node, when no TPC command is received.

In one aspect, the Reference IAB node may compare the UL transmit power with the threshold UL power when the TPC command is received, and may stop the increase of UL power when the UL transmit power is more than or equal to the threshold UL power.

In one aspect, the signalling between Parent IAB node and Reference IAB node may be performed using at least one of Radio Resource Control (RRC) signalling, Medium Access Control-Control Element (MAC-CE) signalling, and physical layer signalling.

In one aspect, the initial value for the threshold UL transmit power may be determined using at least one of channel condition of network, and DL power spectral density.

In one aspect, the threshold UL transmit power may be less than or equal to maximum available power at the Reference IAB node.

In one aspect, the Parent IAB node may receive an information of interference caused to other ongoing transmission by the increased UL transmit power of Reference IAB node from at least one of a Donor node and a victim IAB node. The information of interference may be received by the Donor IAB node from the victim IAB node. The Parent IAB node may reassign a new value for the threshold power equal to the UL transmit power at the instant of interference based on information from at least one of the Donor IAB node and the victim IAB node.

In another aspect, a Reference IAB node may detect power constraint when the Reference IAB node is using single panel for transmitting uplink (UL) and downlink (DL) traffic in both backhaul link and access link in any of Space Division Multiplexing (SDM) mode and Frequency Division Multiplexing (FDM) mode. An MT of the Reference IAB node may allot an Uplink (UL) transmit power based on a UL power control indication from a Parent IAB node. The Reference IAB node may receive an indication of required DL transmit power using a UL control channel from a Child IAB node. The Reference IAB node may compute a DL transmit power based on at least one of the indication of required DL transmit power, the target throughput, Bit Error Rate, total remaining available power, and a parameter for Pathloss to the Child IAB node. The Reference IAB node may compute the DL transmit power to the access link. The Reference IAB node may allot a remaining power to one of backhaul link to the Parent IAB node and one of access link to the user and backhaul link to the Child IAB node, based on load.

In one aspect, the indication for required DL transmit power may be one of an absolute power value, and is present as increments or decrements in existing power values.

In one aspect, the parameter for Pathloss to the Child IAB node may indicate DL Pathloss of backhaul link to the Child IAB node. The DL Pathloss may be considered as equal to UL Pathloss of the link measured by the Reference IAB node, based on reciprocity.

In one aspect, the Reference IAB node may compute the DL transmit power to the access links to users based on at least one of achievement of five percentile performance at required distance at a cell edge, power requirement of cell specific signals including at least one of Synchronization Signal Block (SSB), Channel State Information Reference Signal (CSI-RS), and the power available after allocation of UL transmit power to Parent IAB node and DL transmit power to Child IAB node.

In one aspect, the Reference IAB node may share total available power for DL access link equally among various DL channels in the access link.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrate a typical Integrated Access and Backhaul (IAB) network, in accordance with prior art.

FIG. 2 illustrates a flow-chart depicting a method for measurement of interference by the Reference IAB node based on interference emulation using Reference Signal (RS), in accordance with an embodiment of the present invention.

FIG. 3(a) illustrates a Reference IAB node with simultaneous receptions from the Parent IAB node and the Child IAB node, in accordance with an embodiment of the present invention.

FIG. 3(b) illustrates the gain of the UL receive beam in the direction of DL transmit beam at Reference IAB node, in accordance with an embodiment of the present invention.

FIG. 4 illustrates a flowchart depicting a proactive method of measurement of interference before actual UL reception using UL reception beam, in accordance with an embodiment of the present invention.

FIG. 5(a) illustrates a flow chart depicting a method of measurement of interference based on Power ratios configured by the Parent IAB node, in accordance with an embodiment of the present invention.

FIG. 5(b) illustrates a flow chart depicting a method of measurement of interference based on Power ratios configured by the Parent IAB node using number of symbols between the symbol or slot where authentication request is sent and the first symbol or slot of simultaneous operation, in accordance with an embodiment of the present invention.

FIG. 6 illustrates a flowchart depicting a method of reporting the measured interference, in accordance with an embodiment of the present invention.

FIG. 7 illustrates a flowchart depicting a method of decrement of the DL transmit power using one or more link adaptation techniques, in accordance with an embodiment of the present invention.

FIG. 8 illustrates a flowchart depicting a method of partial power control using a TPC command, in accordance with an embodiment of the present invention.

FIG. 9(a) illustrates a guard band between BH link and AC link, in accordance with an embodiment of the present invention.

FIG. 9(b) illustrates transmission power profile for FDM of BH-DL and AC-UL, in accordance with an embodiment of the present invention.

FIG. 9(c) illustrates a flowchart depicting a method of reducing DL power in Edge RBs for simultaneous reception using FDM, in accordance with an embodiment of the present invention.

FIG. 10 illustrates a flowchart depicting a method of DL power control based on PL feedback and link quality without fractional PL compensation, in accordance with an embodiment of the present invention.

FIG. 11 illustrates a flowchart depicting a method of power control for increasing BH efficiency by TPC in TDM of Parent BH link and one of Child BH link and Child AC links, in accordance with an embodiment of the present invention.

FIG. 12(a) illustrates power sharing between BH-UL and DL links, in accordance with an embodiment of the present invention.

FIG. 12(b) illustrates a flowchart depicting a method of power sharing between BH and AC links in simultaneous transmission mode, in accordance with an embodiment of the present invention.

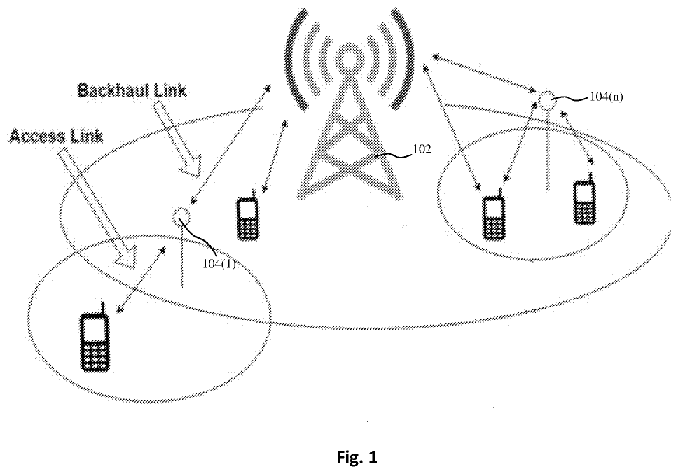

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

The present invention relates to methods of power management in an Integrated Access and Backhaul (IAB) network. The present invention discloses methods of measuring and reporting interference in simultaneous reception in at least one of FDM and SDM modes and interference in TDM modes in an IAB. The present invention further discloses power control processes for mitigation of interference. One or more combination of the described methods may be used to mitigate interference using power control.

In one embodiment, interference may be measured based on interference emulation using Reference Signals (RS). Consider a Reference IAB node may be simultaneously receiving data from its Parent IAB node and the Child IAB node in Space Division Multiplexing (SDM) mode with overlapped time-frequency resources. The Reference IAB node may be experiencing packet failure in transmission and reception of uplink (UL) and downlink (DL) traffic in both backhaul link and access link. If IAB node finds that there are many packet failures, the Reference IAB node initiates measurement of interference and indicates to the Parent IAB node. The interference caused by the DL reception may be measured at the Distributed Unit (DU) of the Reference IAB node. The interference may be measured using Reference Signals (RS). In 4^{th} generation (4G) and 5^{th} generation (5G) wireless communication systems, the RS includes various DL Reference Signals (DL-RS) such as Channel State Information-Reference Signals (CSI-RS), Demodulation Reference Signal (DMRS), and Phase Tracking Reference Signal (PTRS) on which the interference can be measured. Besides the existing reference signals, a new reference signal may also be used for the purpose of the interference measurement. A request for configuration of the DL-RS for interference measurement is sent by the Reference IAB node. A Mobile Termination (MT) of the Reference IAB node may send a request to the Parent IAB node to configure the DL-RS. This is achieved using a trigger sent in control information part of channel from MT of the Reference IAB node to the Parent IAB node. A request may also be sent by the DU of the Reference IAB node to the Donor IAB node for configuration of the Parent IAB node for DL-RS transmission periodically, semi periodically or in an aperiodic way. The Parent IAB node may configure the DL-RS for transmission either on a periodic, semi-periodic basis or aperiodic basis. The allocated DL-RS configuration information containing time-frequency locations of RS, RS sequence, RS precoder and RS transmit power, may be signalled by the DU of the Parent IAB node to one of the MT of the Reference IAB node or the DU of the Reference node. The allocated DL-RS configuration information may also be shared with the DU of the Reference IAB node by the Donor IAB node by getting configuration information from the Parent IAB node, if the RS request went to the Parent IAB node through the Donor IAB node. The configuration information of the DL-RS may also be shared by the MT of the Reference IAB node with the DU of the Reference IAB node, when the configuration information is provided to the MT of the Reference IAB by the Parent IAB node.

Measurement of interference may be performed by the DU of the Reference IAB node in the UL resources in which the corresponding DL-RS are present. The Reference IAB node may not schedule any transmission in the UL for the Child IAB node, in order to enable accurate interference measurement in the corresponding time-frequency resources where the DL-RS are scheduled. Since, no transmission is scheduled by the Reference IAB node for the Child IAB node, the received signal at the DL-RS resource locations contains only the interference signal and the noise. The measurement of interference may be in terms of at least one of Reference Signal Receive Power (RSRP), Received Signal Strength Indicator (RSSI), and Reference Signal Received Quality (RSRQ).

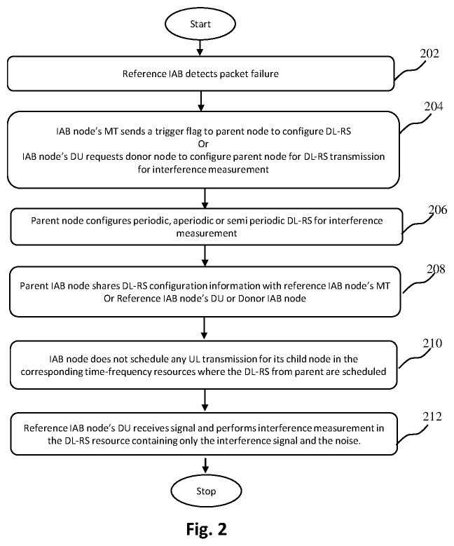

FIG. 2 illustrates a flow-chart depicting a method for measurement of interference by the Reference IAB node based on interference emulation using Reference Signal (RS). At step 202, the Reference IAB node detects packet failures. At step 204, the Reference IAB node performs one of: (i) sending a trigger flag from the MT of the Reference IAB node for configuration of the DL-RS for measurement of interference, to the Parent IAB node, and (ii) sending a request by the DU of the Reference IAB node to the Donor IAB node for instructing the Parent IAB node for DL-RS transmission for measurement of interference. At step 206, the Parent IAB node configures a DL-RS for aperiodic, periodic or semi-periodic DL-RS transmission. At step 208, the Parent IAB node shares the configuration information of the DL-RS with one of the MT of the Reference IAB node, DU of the Reference IAB node, and the Donor IAB node. At step 210, the Reference IAB node does not schedule any transmission for the Child IAB node where DL-RS are scheduled. At step 212, the DU of the Reference IAB node receives a signal at a location of the time-frequency resources corresponding to DL-RS location, containing only the interference signal and the noise.

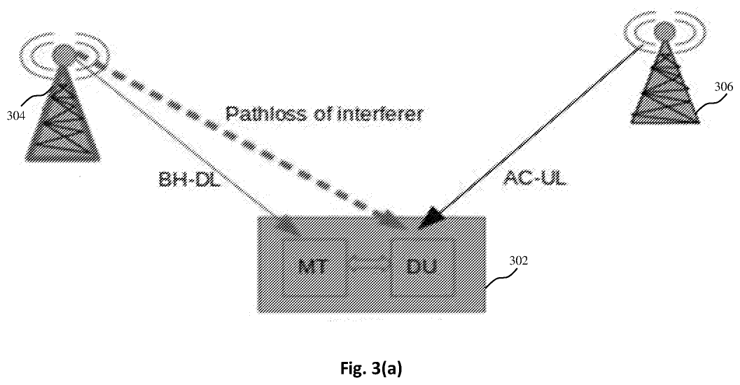

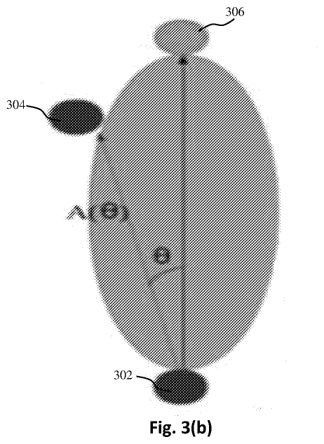

In one embodiment, interference may be measured proactively before actual Uplink (UL) reception, using UL reception beam. FIG. 3(a) illustrates a Reference IAB node (302) with simultaneous receptions from the Parent IAB node (304) and the Child IAB node (306). Considering the Reference IAB node with simultaneous reception, the Reference IAB node measures the Path Loss (also referred to as PL or pathloss) between the beam pair containing DL transmission beam from the Parent IAB node and UL reception beam at the DU of the Reference IAB node. PL estimation is performed by the MT of the Reference IAB node or the DU of the Reference IAB node. Measurements may be performed over any already configured known Reference signal or other known signal transmitted by Parent IAB node or a separate set of reference signals transmitted by the Parent IAB node upon request from the Reference IAB node. The configuration information of the DL signal transmitted by the Parent IAB node includes at least one of a time locations, frequency locations, RS sequence, RS transmit power, channel content and channel average power. For intra panel case with MT and DU sharing common hardware, PL estimated by the MT of the Reference IAB node will be considered for PL at the DU of the Reference IAB node. This is the path loss experienced between the DU of the Parent IAB and the DU of the Reference IAB node. The calculated Pathloss is given by the first equation mentioned below:

PLcalculated=PLactual−Gr−Gt,

In the above mentioned equation, PLactual denotes the coupling gain created by a channel in dB, Gt denotes an antenna gain at the transmitter in dB and Gr denotes an antennae gain at the receiver in dB.

FIG. 3(b) illustrates the gain of the UL receive beam A(θ) in the direction of DL transmit (tx) beam (θ) at Reference IAB node. The gain of the UL receive beam A(θ) may be calculated (using beam equation existing in prior art). Beam direction (θ) is obtained from the MT of the Reference IAB node. This gain of the UL receive beam A(θ) represents the value of Gr in the above equation. Thus, the first equation may be written as the below mentioned second equation:

PLcalculated+A(θ)=PLactual−Gt,

In the above mentioned equation, the parameters PLcalculated and A(θ) are known.

For a target Channel Quality Indicator (CQI) or a Modulation and Coding Scheme (MCS) required in the UL reception from the Child IAB node to the Reference IAB node, the minimum required Signal to Interference and Noise Ratio (SINR) may be computed. The maximum tolerable interference power Pint, max may be derived from the minimum SINR required and target received power PO. Interference seen at Reference IAB node is the unwanted reception at DU due to DL transmit power Pt from the Parent IAB node may be given as the following equation:

Pint=Pt−(PLactual−Gt−Gr),

In the above mentioned equation, using the computed values of (PLactual−Gt) from the second equation and taking DL transmit power Pt as constant, threshold Pint,max will provide threshold value of receiver gain Gr at the DU of the Reference IAB node, i.e., Gr0. The value of Pt is either considered to be equal to any known DL-RS transmission power or obtained from the Parent IAB node as an average DL power. If A(θ) is greater than or equal to Gr0, it means there is high interference from DL transmission at the DU. Thus, one of a modification in receiver gain at the DU and change in DL transmission power of Parent IAB node is needed.

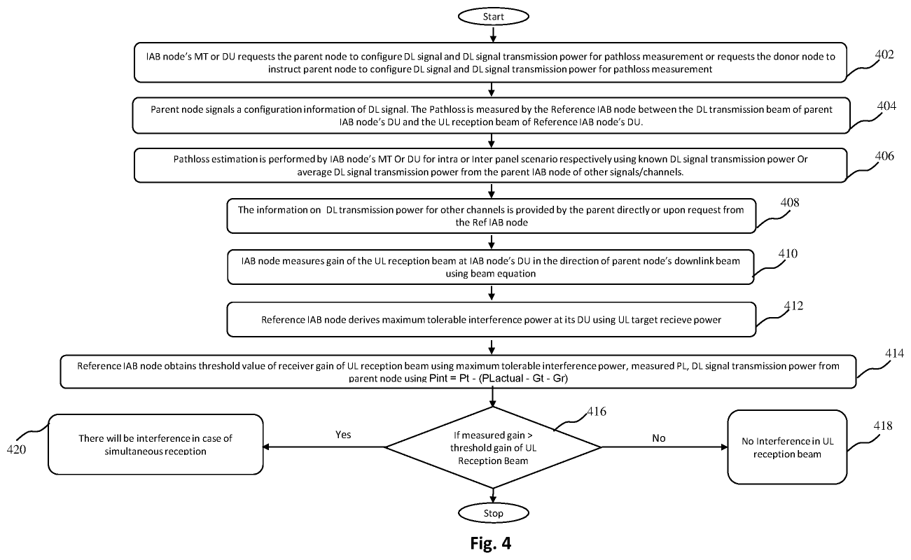

FIG. 4 illustrates a flowchart depicting a proactive method of measurement of interference before actual UL reception using UL reception beam. At step 402, the MT of the Reference IAB node or the DU of the Reference IAB node requests one of either the Parent IAB node for configuration of a DL signal and a DL signal transmission power for pathloss measurement or the Donor IAB node to instruct the Parent IAB node for configuration of the DL signal and the DL signal transmission power for pathloss measurement. The DL signal may include a DL-RS, Synchronization Signal Block (SSB), DL data channel, or control channel. At step 404, the Parent IAB node signals a configuration information of the DL signal including the DL signal transmission power for pathloss measurement. The pathloss is measured between the DL transmission beam of the DU of the Parent IAB node and the UL reception beam of the Reference IAB node's DU. At step 406, pathloss estimation is performed by one of the MT of the Reference IAB node in case of intra panel scenario and the DU of the Reference IAB node in case of inter panel scenario, based on known DL signal transmission power or average DL signal transmission power of other channels, obtained from the Parent IAB node. At step 408, the information on DL transmit power for other channels is provided by the Parent IAB node either directly to the Reference IAB node or upon request from the Reference IAB node. At step 410, the Reference IAB node measures a gain of the UL reception beam at the DU of the Reference IAB node in the direction of a Downlink (DL) beam of the Parent IAB node using beam equation. The direction of the DL beam of the Parent IAB node is provided by MT of the Reference IAB node to the DU of the Reference IAB node. At step 412, the Reference IAB node derives maximum tolerable interference power at the DU of the Reference IAB node using UL target received power. At step 414, the Reference IAB node obtains threshold value of receiver gain of UL reception beam based on maximum tolerable interference power, measured PL, DL signal transmission power from the Parent IAB node using Pint=Pt−(PLactual−Gt−Gr). At step 416, the Reference IAB node determines whether measured gain is greater than threshold gain of UL reception beam. If the measured gain is lesser than the threshold gain of UL reception beam, the method moves to step 418. At step 418, there is negligible interference in UL reception beam. If the measured gain is greater than threshold gain of UL Reception beam, the method proceeds to step 420. At step 420, a comparison of a value of measured gain with the threshold gain of UL Reception Beam, is utilized for determining level of interference caused by DL reception from Parent IAB node on the UL reception from the Child IAB node in case of simultaneous reception. If the value of measured gain is greater than the threshold gain of UL Reception Beam, a significant interference in UL reception beam is indicated and if the value of measured gain is less than the threshold gain of UL Reception Beam, a negligible interference in UL reception beam is indicated.

In one embodiment, the interference may be measured using power ratios configured by the Parent IAB node. Considering a New Radio system, the Base Station (BS/gNB) sends DL power offsets for various DL signals and channels. These offsets are considered as power ratios by UEs. The UE considers that the power of all DL signals or channels are associated with each other in such a way that any change in the power of a particular signal will change the power of the signal(s) or channel(s) linked with it by the associated power ratios. For simultaneous reception of IAB BH and AC links, the Reference IAB node may use the power ratios and one of a CSI-RS (Channel State Information-Reference Signal) or Synchronization Signal Block (SSB) power configured to the MT of the IAB by the Parent IAB node to predict the approximate power of all DL signals or channels transmission including data transmission at or before start of or during the simultaneous operation. The predicted power may be used to measure the upcoming or ongoing interference caused by BH-DL reception at AC-UL reception in a proactive way. The power ratios may include ratio of power of at least one of DL data, DL control, DL signal, and channel power to one of the CSI-RS power and SSB power.

The power ratios may also be used along with previous methods for interference measurements performed using RSs to get more accurate value of interference caused by DL data channels. Last DL PL or RSRP measured by the MT of the Reference IAB node may be used for the interference prediction of any particular channel or signal including data as given by following equation:

P_{data}=R₁*P_{CSI-RS},

In the above mentioned equation, P_{data} denotes DL data channel transmission power and P_{CSI-RS} denotes CSI-RS transmit power.

Thus, the above equation may be written as below equation,

Int_{data(dB)}=P_{data(dB)}−PL_{(dB)} (or) Int_{data(Linear)}=R₁*RSRP_{CSI-RS}

In the above mentioned equation, R1 denotes linear value of power offset or ratio of DL data power to CSI-RS power, Int_{data} denotes Interference caused by DL data received at Reference IAB, and RSRP_{CSI-RS} denotes linear value of RSRP measured at CSI-RS.

The Reference IAB node may send an authentication request to the Parent IAB node for the power ratios either in UCI or along with UL data. The Parent IAB node may respond with the authentication indicator in at least one of radio resource control (RRC), medium access control-control element (MAC-CE) or downlink control information (DCI) if the same power ratios will be used for the upcoming DL transmissions at the DU of the Parent IAB node. Upon change in DL transmission power, the associated new power ratio values may be informed to the MT of the Reference IAB node by the Parent IAB node through one of the RRC, MAC-CE or DCI. If the power changes after the start of simultaneous reception, then the new ratios may be informed again dynamically. It may be beneficial for the Parent IAB node to know the start time of simultaneous operation of the Reference IAB to send the authentication or the values of ratios. The start time may be either informed by the Donor IAB node or the MT of the Reference IAB node in UL of the Reference IAB node before starting the simultaneous operation to the Parent IAB node.

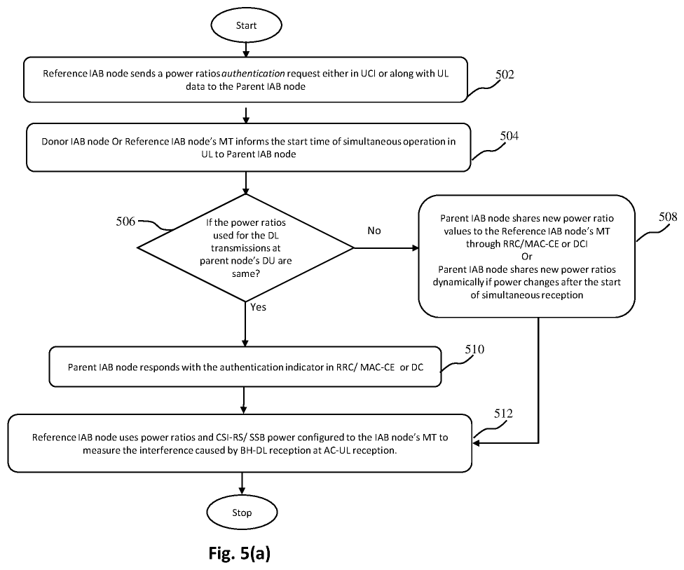

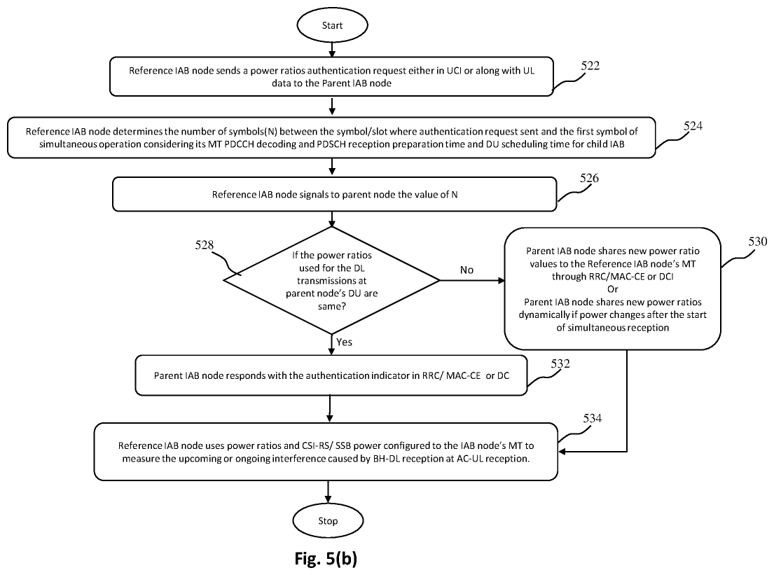

FIG. 5(a) illustrates a flow chart depicting a method of measurement of interference based on Power ratios configured by the Parent IAB node. At step 502, the Reference IAB node sends a power ratios authentication request either in UCI or along with UL data to the Parent IAB node. At step 504, the Donor IAB node or the MT of the Reference IAB node informs the start time of simultaneous operation to the Parent IAB node. At step 506, the Parent IAB node determines if power of at least one of a first DL signal, a first DL channel, and associated power ratio at the DU of the Parent IAB node are same. If the power of at least one of the first DL signal, the first DL channel, and the associated power ratios are not same, a corresponding change in power of other channels linked to the first upcoming at least one of DL signal and channel is caused, then the method proceeds to step 508. At step 508, the Parent IAB node performs one of: (i) sharing new power ratio values to the MT of the Reference IAB node through one of RRC, MAC-CE or DCI (ii) sharing new power ratios dynamically if power changes after the start of simultaneous reception. If the power ratios are same, then the method moves to step 510. At step 510, the Parent IAB node responds with the authentication indicator in one of RRC, MAC-CE or DC. After both the steps 508 and 510, the method proceeds to step 512. At step 512, the Reference IAB node measures the interference caused by Backhaul Downlink (BH-DL) reception at AC-UL reception using power ratios and either power of power of Channel State Information Reference Signal (CSI-RS) or power of Synchronization Signal Block (SSB) power configured to the MT of the Reference IAB node.

In another embodiment, the Reference IAB node may send an authentication request to the Parent IAB node for the power ratios either in UCI or along with UL data. The authentication request may also serve the purpose of start time indication for simultaneous reception and is sent at N symbols or slots before first symbol of simultaneous reception. The value of number of symbols (N) is informed to the Parent IAB node by the Reference IAB node. Here, first symbol of N symbols is between the last symbol of DCI scheduling UL transmission at Child IAB node and the minimum processing time required by the Reference IAB node for the simultaneous operation. The Reference IAB node determines the number of symbols or slots (N) between the symbol or slot where authentication request is sent and the first symbol or slot of simultaneous operation considering Physical Downlink Control Channel (PDCCH) decoding, Physical Data Shared Channel (PDSCH) reception preparation time and DU scheduling time for Child IAB node.

FIG. 5(b) illustrates a flow chart depicting a method of measurement of interference based on Power ratios configured by the Parent IAB node using number of symbols between the slot where authentication request is sent and the first slot of simultaneous operation. At step 522, the Reference IAB node sends a power ratios authentication request either in UCI or along with UL data to the Parent IAB node. At step 524, the Reference IAB node determines the number of symbols (N) between the slot where authentication request sent and the first slot of simultaneous operation. The value of N ranges between a maximum and a minimum value. The maximum value is the duration between the last symbol of DCI transmitted at Reference IAB node for scheduling UL transmission at the MT of the Child IAB node and the start time of simultaneous reception at Reference IAB node. The minimum value is the processing time required by the Reference IAB node for the simultaneous operation, considering MT PDCCH decoding and PDSCH reception preparation time, and DU processing time for UL reception from the Child IAB node. At step 526, the Reference IAB node signals the value of N to the Parent IAB node. At step 528, the Parent IAB node determines if the power ratio used for the upcoming DL transmissions at the DU of the Parent IAB node are same. If the power ratios are not same then the method proceeds to step 530. At step 530, the Parent IAB node performs one of: (i) sharing new power ratio values to the MT of the Reference IAB node through one of RRC, MAC-CE or DCI (ii) sharing new power ratios dynamically if power changes after the start of simultaneous reception. If the power ratios are same, then the method moves to step 532. At step 532, the Parent IAB node responds with the authentication indicator in one of RRC, MAC-CE or DC. After both the steps 530 and 532, the method proceeds to step 534. At step 534, the Reference IAB node uses power ratios and CSI-RS or SSB power configured to the MT of the Reference IAB node to measure the upcoming or ongoing interference caused by BH-DL reception at AC-UL reception.

In one embodiment, the measured value of interference may be reported. The resulting SINR is calculated based on a calculated interference power at the Reference IAB node and the corresponding value of CQI or MCS may be found out. The interference power is calculated using at least one of a Downlink Reference Signal (DL-RS), Synchronization Signal Block (SSB), DL data channel, and control channel, from Parent IAB node. If the calculated value of CQI or MCS is less than the target value and the interference due to DL reception is also significant at the Reference IAB node, then the Reference IAB node will convey information of the interference and the resources where interference occurred to the Parent IAB node. The information may be shared from DU of the Reference IAB node to the MT of the Reference IAB node. The MT of the Reference IAB node may inform the Parent IAB node by at least one of Li control signaling, MAC-CE or through other higher layer parameters. In 4G and 5G systems, the control channel signalling is termed as UL control information (UCI). Additional field for indication of increase in interference may be included in at least one of UCI, MAC-CE or Higher layer signalling.

The resources where the interference occurred may also be reported to the Parent IAB node as an assistant information, such that the Parent IAB node may perform selective DL power control specifically to the resources reported by the Reference IAB node and may use conventional DL power allocation for the remaining resources. Alternately, the DU of the Reference IAB node may also inform this to the Parent IAB node through the Donor IAB node or any new channel may also be used for this signalling from Reference IAB node to the Parent IAB node as an indication for interference requesting DL power reduction. The Parent IAB node may consider the request for modification in DL power until the same beam pair is latched and after the beam pair changes, Parent IAB node will stop using the DL power modified by the request received for previous latched beam pair and calculates new DL power for the new beam pair. The newly latched beam pair index is indicated by the Parent IAB node to the Reference IAB.

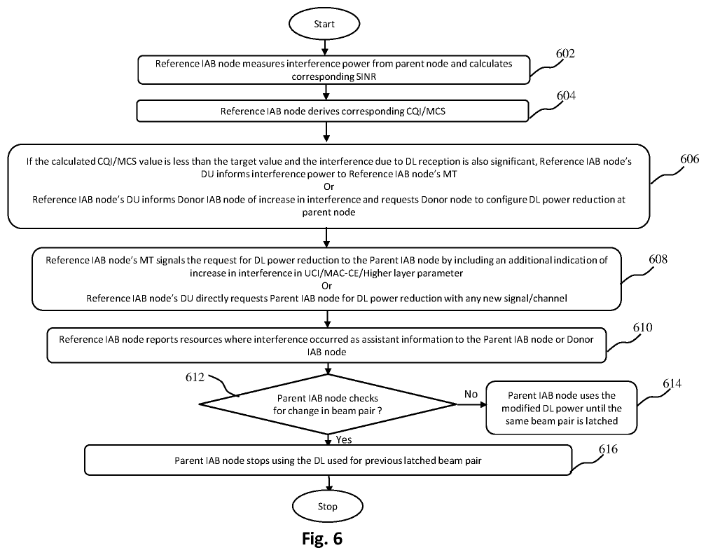

FIG. 6 illustrates a flowchart depicting a method of reporting the measured interference. At step 602, the Reference IAB node measures interference power from the Parent IAB node and calculates corresponding SINR. At step 604, the Reference IAB node derives corresponding CQI or MCS. At step 606, if at least one of the calculated CQI or MCS value is less than the target value and the interference from the DL reception is significant, the DU of Reference IAB node performs one of: (i) informing interference power to the MT of the Reference IAB node and MT of the Reference IAB node signals an indication of increase in interference to the Parent IAB node and (ii) informing the Donor IAB node of increase in interference and requesting the Donor IAB node to configure DL power reduction at the Parent IAB node. At step 608, the MT of the Reference IAB node signals the request for DL power reduction to the Parent IAB node by including an additional indication of increase in interference in at least one of UCI, MAC-CE or Higher layer parameter. The DU of the Reference IAB node may directly request the Parent IAB node for DL power reduction through at least one of a new signal and channel or the Donor IAB node may also signal for reduction of DL power. At step 610, the Reference IAB node reports resources where interference occurred as assistant information to the Parent IAB node or Donor IAB node. At step 612, the Parent IAB node checks for change in beam pair, if there is no change in beam pair the method then proceeds to step 614. At step 614, the Parent IAB node uses the modified DL power until the same beam pair is latched. If there is a change in beam pair, then the method moves to step 616. At step 616, the Parent IAB node stops using the DL power used for previous latched beam pair and newly latched beam pair index is indicated by the Parent IAB node to the Reference IAB through at least one of DC and MAC-CE.

In one embodiment, power control procedures may be used to mitigate interference. The DL transmit power may be decreased using at least one of link adaptation techniques and adjusting beam gain. The Parent IAB node, upon receiving the indication from the Reference IAB node, will consider decreasing the DL transmit power or decide to use other link adaptations techniques to decrease DL power. The other link adaptations techniques include using lower order MCS, reducing number of layers transmitted to decrease DL power. The decreased DL transmit power will be applied up to a certain time period such as up to a timer expiry and is signalled to the Reference IAB node. The Parent IAB node will use either the conventional DL power as in NR or last updated DL power after the timer expires based on a signal received from the Reference IAB node until a new indication for DL power is received by the Parent IAB node. If a new indication comes within the timer duration, the Parent IAB node will consider that also if it can afford further reduction in DL power. However, the reduction in DL power is based on at least one of following constraints: (i) the power of important signals such as SSB and CSI-RS is not compromised (ii) the target DL MCS is not affected by the reduction in DL power. The parent IAB node configures its Child IAB node with DL reference signals for interference measurement and also configures the Child IAB node to feedback the DL channel quality values. The Parent IAB node will receive an indication for the interference and the value of DL channel quality from the Child IAB node. If the reported DL CQI from the childIAB node is higher than the target CQI, the parent IAB node will decrease its DL transmission power.

If the above constraints are not satisfied, the DL power cannot be reduced, and then the Reference IAB node will switch to TDM mode. Alternatively, adjusting the value of Gr (receive beam gain) of the UL reception beam, in the direction of the Parent IAB node will be done to mitigate power imbalance issue.

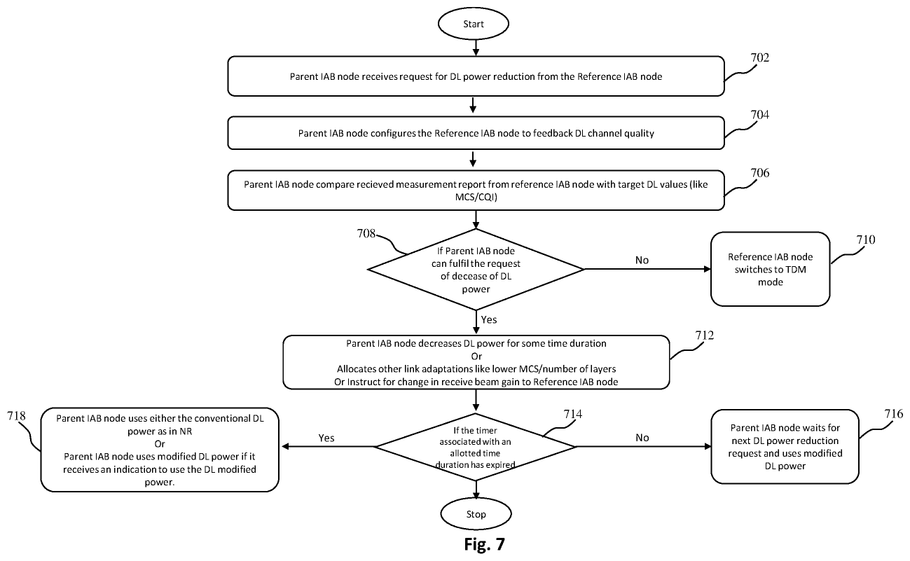

FIG. 7 illustrates a flowchart depicting a method of decrement of the DL transmit power using at least one of link adaptations and adjusting beam gain. At step 702, the Parent IAB node receives request for DL power reduction from the Reference IAB node. At step 704, the Parent IAB node configures the Reference IAB node with DL-RS for interference measurement and to feedback DL channel quality. At step 706, the Parent IAB node compares received measurement report from Reference IAB node with target DL values including MCS or CQI. At step 708, the Reference IAB node determines if Parent IAB node can fulfil the request of decrease of DL power. If the Parent IAB node cannot fulfil the request, then the method proceeds to step 710. At step 710, the Reference IAB node switches to TDM mode. If the Reference IAB node can fulfil the request, the method then moves to step 712. At step 712, the Parent IAB node decreases DL power for some time duration and indicates a change in power to the Reference IAB node through one of DCI and MAC-CE signalling. The Parent IAB node may also perform link adaptation techniques for reduction of DL power. The link adaptation techniques include reducing MCS and reducing number of spatial layers. At step 714, the Parent IAB node monitors if the timer associated with an allotted time duration has expired. If the time has not expired then the method proceeds to step 716. At step 716, Parent IAB node waits for next DL power reduction request and uses modified DL power. If the timer has expired then the method proceeds to step 718. At step 718, the Parent IAB node uses one of the conventional DL power as in NR and the last updated DL power when an indication to use the last modified DL power is received.

In one embodiment, partial power control in DL based on Transmit Power Control (TPC) command may be used to mitigate interference. Considering a Reference IAB node operating in simultaneous reception from BH-DL and either BH-UL or AC-UL in either SDM or FDM mode, the issue of power imbalance arising may be solved by employing DL power control taking inspiration from existing UL power control. However, to adopt exactly same algorithm as used for UL in DL can be resource consuming and unnecessary increase network overhead. Thus, a practical way to mitigate the power imbalance issue causing interference in weaker signal is to use partial power control in DL. The Reference IAB upon facing interference at AC-UL reception by BH-DL reception may send negative TPC request to the Parent IAB node. Either the format of the TPC commands similar to those used in NR systems may be reused as TPC request or a one bit indication in UL may be used. The corresponding TPC values may be either the existing values described in NR or any other new values in the form of range with a number of levels. A range of negative TPC values may be determined by the Parent IAB node starting from zero to a negative minimum value depending on target MCS and minimum transmit power of the DU of the Parent IAB node. Upon receiving the TPC request, Parent IAB node may take into consideration for defining DL power, if it can afford the decrement in DL power. The Parent IAB node decreases the DL power with the defined step size with every TPC request until it reaches the last value of TPC in the range and gives acknowledgement to the Reference IAB node for the received TPC request. Parent IAB node may wait for next TPC request until a timer duration. After timer duration expires, Parent IAB node may stop the power control for DL and continue the transmission either with conventional DL power as defined for NR or with modified DL power based on the received TPC request, if the Reference IAB node sends an indication to use modified DL power within the timer. These TPC requests can be sent either in UCI, MAC or can be sent along with UL data. This method does not require exchange of all the parameters between Parent IAB node and Child IAB node, but takes into account only TPC part of power control making it a partial power control, which will help in DL transmit power reduction at parent IAB node side, thus reducing interference at Reference IAB node.

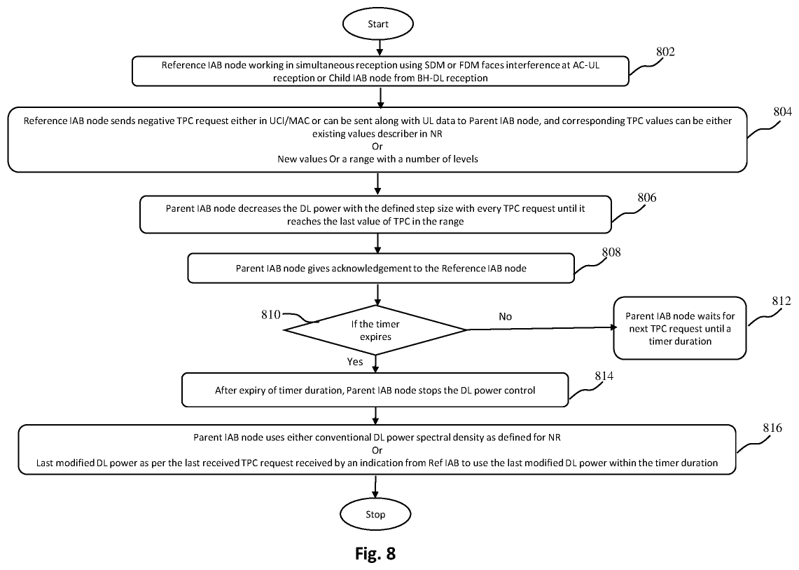

FIG. 8 illustrates a flowchart depicting a method of partial power control using a TPC command. At step 802, the Reference IAB node working in simultaneous reception using SDM or FDM faces interference caused by the downlink (DL) reception in backhaul link on uplink (UL) reception in access link. At step 804, the Reference IAB node sends negative TPC request either in UCI or MAC or along with UL data to Parent IAB node, and corresponding TPC request can be one of either existing values of TPC commands described in NR for UL, new values in the form of one of range of TPC values with a number of levels, a new offset value and one bit indication. At step 806, the Parent IAB node decreases the DL power with the defined step size with every TPC request until it reaches the last value of TPC in the range. At step 808, the Parent IAB node gives acknowledgement to the Reference IAB node. At step 810, the Parent IAB node determines if the timer has expired. If the timer has not expired then the method proceeds to step 812. At step 812, the Parent IAB node waits for next TPC request until a timer duration. If the time expires then the method moves to step 814. At step 814, the Parent IAB node stops the DL power control. At step 816, Parent IAB node uses one of either conventional DL power as defined for NR or modified DL power based on the received TPC request, if an indication from the Reference IAB node is received to use the modified DL power within the timer duration.

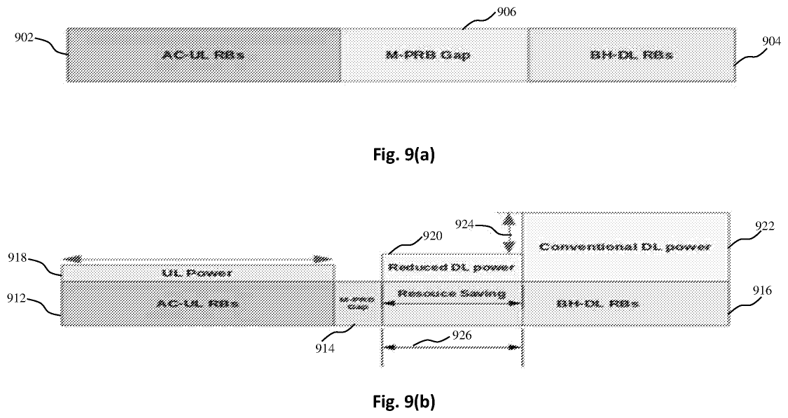

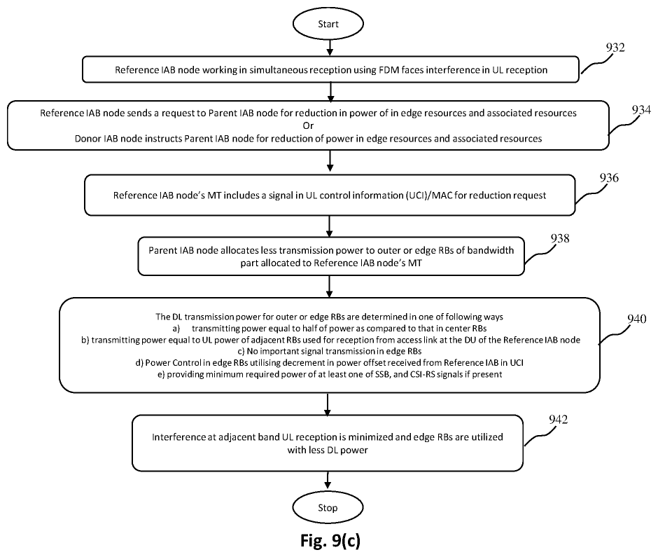

In one embodiment, the DL power is reduced in Edge resource blocks (RBs) for simultaneous reception using FDM. Considering a case of simultaneous reception from Parent IAB node and Child IAB node using FDM, the interference from the Parent IAB node can be avoided using guard band between the resources allocated for Parent IAB node and Child IAB node. However, due to high power difference in DL and UL receptions, there may still be interference. FIG. 9(a) illustrates a guard band between BH link and AC link. As illustrated in FIG. 9(a), using more guard band such as M number of physical resource blocks (M-PRBs) (902) used as guard band between backhaul downlink resource blocks (BH-DL-RBs) (904) and access uplink resource blocks (AC-UL RBs) (906) to reduce the interference, may lead to unnecessary wastage of resources as shown in FIG. 9(a). Hence, upon experiencing interference in UL reception, Reference IAB node indicates to the Parent IAB node a request for reduction of power in edge resources and associated resources. The reduction request may be a 1 bit signalling. The reduction request may be sent in one of UCI, MAC signalling and through Donor IAB node to the Parent IAB node. Parent IAB node upon receiving the request may allocate less transmission power to the DL edge RBs of bandwidth part allocated to MT of the Reference IAB node such as by using low MCS at edge RBs.

FIG. 9(b) illustrates transmission power profile for FDM of BH-DL and AC-UL. As illustrated in FIG. 9(b), block (912) denotes AC-UL RBs, block (914) denotes M-PRB gap, block (916) denotes BH-DL RBs, block (918) denotes UL power, block (920) denotes Reduced DL power and block (922) denotes conventional DL power. Further, saving resources in Edge RBs (926) of BH-DL RBs is depicted. The gap between block (920) and (922) denotes power reduction (924). The power reduction (924) may be at least one of (i) 3 dB causing half power transmission at edge RBs compared to full DL power in centre DL RBs (ii) equal to UL transmission power from Child IAB node by getting information from Reference IAB node (iii) Parent IAB node may avoid transmission of important DL RS or control information at edge RBs which require higher power but transmit other information with less power (iv) an offset limited to a value providing enough power for SSB, CSI-RS and other important signals if present. The power reduction (924) may also be achieved by using power control (PC) for edge RBs indicating decrement in power offset in UCI from Reference IAB node. Thus, by reducing power in outer or edge RBs, the interference at adjacent band UL reception at Reference IAB node may be minimized and also the resource utilization may be increased by reducing guard band and the edge RBs may be utilized with less DL power.

FIG. 9(c) illustrates a flowchart depicting a method of reducing DL power in Edge RBs for simultaneous reception using FDM. At step 932, the Reference IAB node working in simultaneous reception using FDM faces interference in UL reception in access link by the adjacent resources used for the BH-DL reception. At step 934, performing by any one of: (i) Reference IAB node requesting to Parent IAB node for reduction of power in edge resources and associated resources (ii) the Donor IAB node instructing the Parent IAB node for reduction of power in edge resources and associated resources. At step 936, the MT of the Reference IAB node includes one bit signal in UCI or MAC for reduction request. At step 938, the Parent IAB node allocates less transmission power to outer or edge RBs of bandwidth part allocated to the MT of the Reference IAB node. At step 940, the DL transmission power for outer or edge RBs are determined in one of following ways a) transmitting power equal to half of power as compared to that in center RBs b) transmitting power equal to UL power of adjacent RBs used for reception from access link at the DU of the Reference IAB node c) No important signal transmission in edge RBs, and d) Power control in edge RBs utilizing a decrement in power offset received from the Reference IAB in UCI, and e) providing minimum required power for at least one of SSB, and CSI-RS signals if present. At step 942, the reduction in transmission power by the Parent IAB node minimizes the interference at adjacent Uplink (UL) reception at DU of Reference IAB node and the edge RBs are utilized.

In one embodiment, the DL power control is based on PL feedback and link quality without fractional PL compensation. Considering the DL power control, the DL transmission power is fixed based on the link quality and DL PL reported by the Reference IAB node. An initial minimum target power value is considered. The minimum target power is equal to the uplink target power used for the same link used by the Parent IAB node scaled with a first offset to account for the corresponding MCS used in DL. The first offset is dependent on modulation and coding scheme (MCS) used by the Parent IAB node. Thereby signaling of target DL power parameter from Reference IAB node is avoided. The Parent IAB node may configure and trigger the resources for measurement and feedback of pathloss and a link quality. The DL PL of the link and the link quality calculated by Reference IAB node may be reported to the Parent IAB node in one of the UCI, MAC, and RRC layer. The received DL PL value along with a second offset dependent on the link quality is added to the minimum DL target power by the Parent IAB node. The DL transmission power of the link is determined by the Parent IAB node based on the following equation:

DL power=DL target power+PL reported by reference IAB+second offset,

In the above mentioned equation, the DL target power denotes the target UL receive power scaled with DL MCS dependent offset. Full DL PL compensation is performed at the Parent IAB node for the PL reported by the Reference IAB node, thereby avoiding signaling of fractional PL compensation factor as used in UL power control. The value of second offset may either be additive or subtractive based on the channel quality. For example, for RBs with good channel quality this value may be negative. The only signalling needed here are DL pathloss and link quality measurement. Thus, a practical DL power control helps to resolve received power imbalance issue at Reference IAB node with less amount signalling.

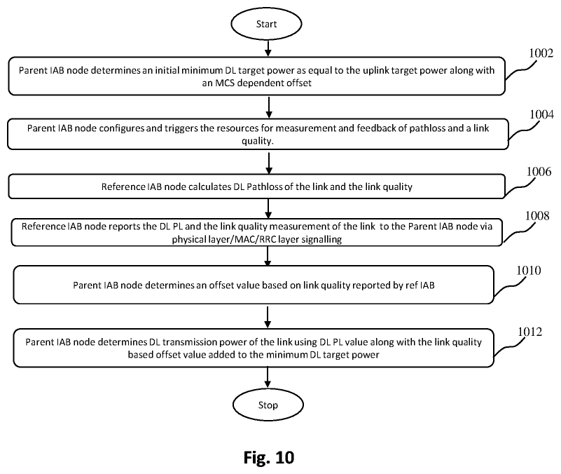

FIG. 10 illustrates a flowchart depicting a method for DL power control based on feedback of PL and link quality without fractional PL compensation. At step 1002, the Parent IAB node determines an initial minimum DL target power as equal to the Uplink (UL) target power along with a first offset. At step 1004, the Parent IAB node configures and triggers the resources for measurement and feedback of pathloss and a link quality. At step 1006, the Reference IAB node calculates DL Pathloss and the link quality measurement of the link. At step 1008, the Reference IAB node reports the DL PL and the link quality measurement of the link to the Parent IAB node via one of physical layer, MAC, and RRC layer signalling. At step 1010, the Parent IAB node determines a second offset value based on link quality reported by the Reference IAB node. At step 1012, the Parent IAB node determines DL transmission power of the link by adding value of DL PL along with the second offset value added to the minimum DL target power in dB.

In one embodiment, power control may be used for increasing BH efficiency by using TPC in case of TDM mode of resource multiplexing between Parent BH link and either Child BH link or Child AC links. For improved BH efficiency, the BH UL power may be increased compared to the UL power calculated based on UL power control, up to some limit. However, this is possible only in case of TDM based resource multiplexing between the Parent BH link and either Child BH link or Child AC link, since there is no scope of interference between BH and AC links in case of TDM scenario. The increase in UL transmit power may be done in steps using TPC commands up to the threshold indicated by the Parent IAB node. The Parent IAB node may decide the threshold based on channel condition of network, DL power spectral density and may be indicated by at least one of physical layer, MAC CE and RRC to the Reference IAB node. The step size for values of TPC command for an IAB node in TDM mode may be increased as compared to the existing values in NR. Table 1 illustrates TPC for increased efficiency in TDM multiplexing for BH and AC.

TABLE 1
TPC for increased efficiency in TDM multiplexing for BH and AC

| TPC Command | Offset in dB |
|---|---|
| 0 | −4 (or) X1 |
| 1 | 0 |
| 2 | 4 (or) X2 |
| 3 | 6 (or) X3 |

The method reduces the number of times the TPC command is transmitted for the same amount of increase in UL transmit power. The TPC command is transmitted by the Parent IAB node upon receiving indication of requirement of increase in BH-UL beyond desired UL power from Reference IAB node. At some point of time, the increased UL power may cause interference to other ongoing transmissions in the network. In such a case, the Victim IAB node experiencing interference due to the increased UL transmit power of Reference IAB node informs the Donor IAB node controlling the whole IAB network or Parent IAB node of the Reference IAB node. The Donor IAB node informs the Parent IAB node about the interference. The transmit power used at the instant where the interference occurs as informed by the Donor IAB node or victim IAB node can also be used as the new value for threshold power at the Parent IAB node. Then the Parent IAB node also take measures to reduce or stop increasing the UL transmit power of Reference IAB node.

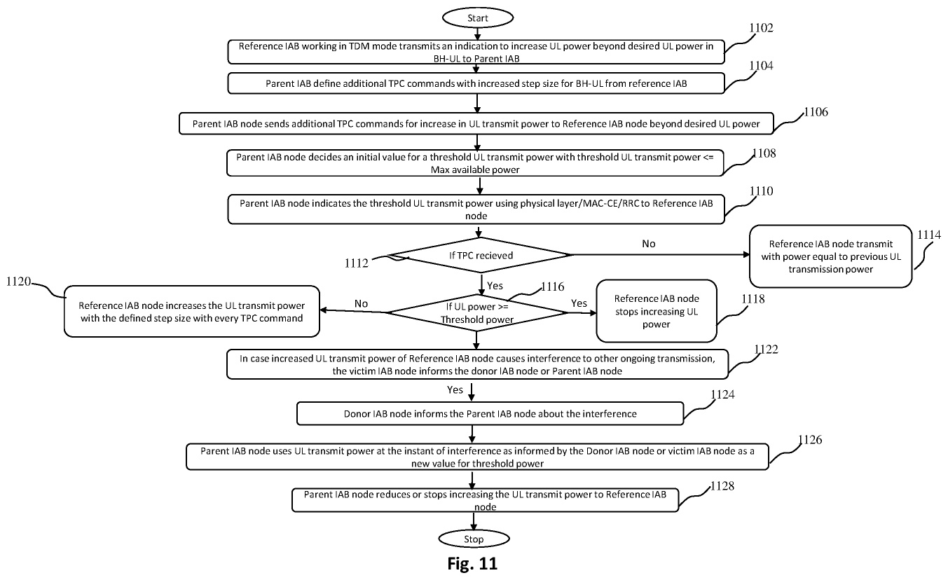

FIG. 11 illustrates a flowchart depicting a method of power control for increasing BH efficiency using TPC in TDM mode of resource multiplexing between Parent BH link and either Child BH link or Child AC links. At step 1102, the Reference IAB working in TDM mode transmits a value of one of desired Uplink (UL) power in Backhaul Uplink (BH-UL) and indication of requirement of increase in BH-UL beyond desired UL power to the Parent IAB node. At step 1104, the Parent IAB node defines TPC commands with increased step size for BH-UL from Reference IAB node as the increased step size reduces the number of times TPC signalling is done. At step 1106, the Parent IAB node sends TPC commands for increase in UL transmit power to Reference IAB node beyond desired UL power. At step 1108, the Parent IAB node decides an initial value for a threshold UL transmit power, where the value of threshold UL transmit power is less than or equal to maximum available power. The initial value for the threshold UL transmit power is determined by the Parent IAB node using at least one of channel condition of network and DL power spectral density. At step 1110, the Parent IAB node indicates the threshold UL transmit power using physical layer, MAC-CE or RRC to the Reference IAB node. At step 1112, the Reference IAB node determines if TPC received. If TPC is not received then the method proceeds to step 1114. At step 1114, the Reference IAB node transmits with power equal to previous UL transmission power. If TPC is received, then the method moves to step 1116. At step 1116, the Reference IAB node determines if UL power is greater than or equal to threshold power. If the UL power is greater than or equal to the threshold power, then the method proceeds to step 1118. At step 1118, Reference IAB node stops increasing UL power. If UL power is lesser than the threshold power, then the method moves to step 1120. At step 1120, the Reference IAB node increases the UL transmit power with the defined step size with every TPC command. At step 1122, in case increased UL transmit power of Reference IAB node causes interference to other ongoing transmission, the Victim IAB node that experiences interference informs to one of the Donor IAB node or Parent IAB node. At step 1124, Donor IAB node informs the Parent IAB node about the interference. At step 1126, the Parent IAB node uses UL transmit power at the instant of interference as informed by the Donor IAB node or victim IAB node as a new value for threshold power. At step 1128, the Parent IAB node reduces or stops increasing the UL transmit power to Reference IAB node.

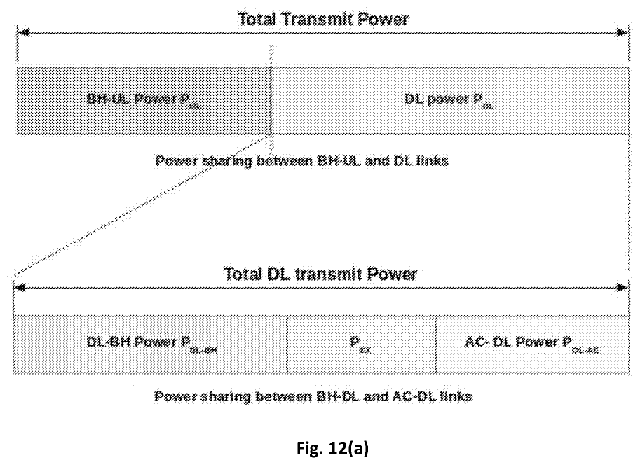

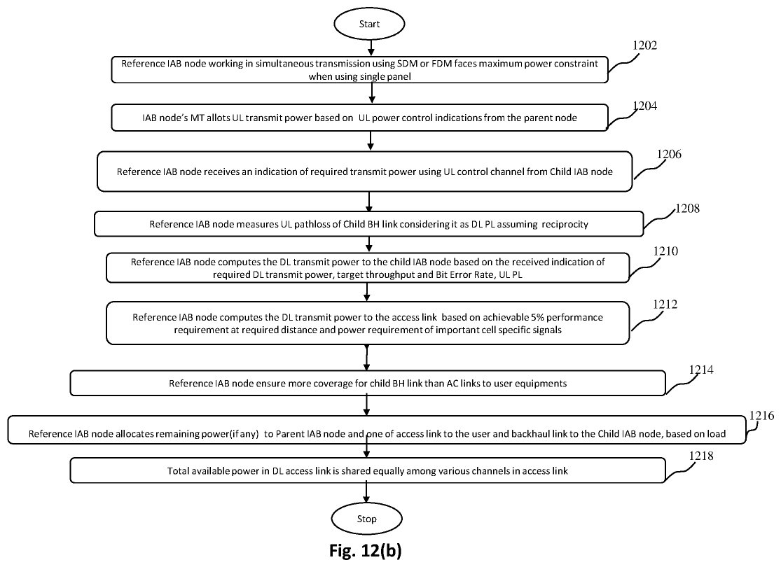

In one embodiment, power control is used for power sharing between BH link and AC link in simultaneous transmission mode. Considering, the FDM and SDM scheme that enables simultaneous transmissions in both BH and AC links, proper power sharing methods between the BH and AC links is crucial for IAB nodes with single panel, as there is a constraint on maximum power. The power sharing mechanism considers the sharing of power between the UL and DL transmissions. FIG. 12(a) illustrates power sharing between BH-UL and DL links. As illustrated in FIG. 12(a), total transmit power is shared between UL and DL transmissions, also represented by the below mentioned equation:

Pₜₒₜ=P_{UL}+P_{DL}

In the above mentioned equation, Pₜₒₜ denotes the total power shared between the UL and DL transmissions, P_{UL} denotes the transmit power in UL BH, while P_{DL} denotes the total power used for DL transmissions. The value of P_{UL} is fixed based on UL power control, which is further determined based on target received power, pathloss, transmit MCS, number of allocated RBs etc. In case of DL transmissions, sharing of power between transmission to Child BH link and Child AC link may also be considered. The DL power sharing may be based on constraints pertaining to Child BH links and Child AC links. In case of Child BH link, the transmit power may be such that the required BH throughput is achieved, since the BH link is an essential link. The DL BH transmit power is decided based on either signaling from the Child IAB node to the Parent IAB node, using UL control channel, indicating the required transmit power or calculated at Reference IAB node. The signaling may be either absolute power value or the increments or decrements to the existing power value. In case of calculating power at Reference IAB node, the Reference IAB node computes the DL transmit power to the Child IAB node based on the target throughput. The required bit error rate (BER) is to be considered. For the target throughput of R and the required BER of Pe, the required data rate is R/(1−Pe). The MCS required to meet the above rate is found out. The pathloss measurements are performed in the UL and the same pathloss is considered in the DL, assuming reciprocity. Using UL pathloss value and required MCS, the DL transmit power may be calculated.

In case of AC UEs, the DL transmit power may be based on at least one of the following constraints: (i) At least 5 percentile performance requirement is achieved at the required distance (cell edge), (ii) the transmit power for important cell specific signals including SSBs and CSI-RS are as per the requirement.

Allocating equal power for Child BH and AC link to User Equipment (UE) may lead to decrease in the coverage of the Child BH link. For example, the coverage D1 is achieved if full power is used in BH, whereas the coverage reduces to D2 when the power is equally shared between UL-BH and DL-AC links. It is required that the coverage for Child BH is always greater than the maximum coverage for AC UE.

P_{DL}=P_{DL_BH}+P_{DL_Acc}+P_{EX},

In the above mentioned equation, P_{DL_BH} denote the power transmitted over the Child BH link and P_{DL_Acc} denote the power transmitted over the AC link to UEs. The factor P_{EX} denotes the additional power remaining after power allocation to Child BH link, Parent BH link and AC link to UEs. Referring back to FIG. 12 (a), remaining transmit power is allocated to either AC or BH link based on load.

FIG. 12(b) illustrates a flowchart depicting a method of power sharing between BH and AC links in simultaneous transmission mode. At step 1202, the Reference IAB node working in simultaneous transmission using SDM or FDM faces maximum power constraint when using single panel. At step 1204, the MT of the Reference IAB node allots UL transmit power based on UL power control indications from the Parent IAB node. At step 1206, the Reference IAB node receives an indication of required transmit power using UL control channel from Child IAB node. The indication value for required UL transmit power may be absolute power value or in the form of increments and decrements in existing power values. At step 1208, the Reference IAB node measures UL pathloss of Child BH link and considers it to be same as DL PL assuming reciprocity. At step 1210, the Reference IAB node computes the DL transmit power to the child IAB node based on at least one of the target throughput, Bit Error Rate, the received indication for required power and UL PL. At step 1212, the Reference IAB node computes the DL transmit power to the access link based on achievable 5% performance requirement at required distance and power requirement of important cell specific signals. At step 1214, the Reference IAB node ensures more coverage for child BH link than AC link to UEs. At step 1216, the Reference IAB node allocates remaining power (if any) to Parent IAB node and one of access link to the UEs and backhaul link to the Child IAB node, based on load. At step 1218, total available power in DL access link is shared equally among various channels in access link.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

1. A method of interference measurement for power management in an integrated access and backhaul (IAB) network, the method comprising:
requesting, by a Reference IAB node, configuration of a Downlink-Reference Signal (DL-RS) for measurement of interference, to one of:
a Parent IAB node, by sending a trigger from a Mobile Termination (MT) of the Reference IAB node, and
a Donor IAB node, by sending a request for instruction to the Parent IAB node for the configuration of the DL-RS, from a Distributed Unit (DU) of the Reference IAB node;
signaling, by the Parent IAB node, a configuration information of at least one of a periodic DL-RS, aperiodic DL-RS and semi-periodic DL-RS, to one of the MT of the Reference IAB node and DU of the Reference IAB node; and
sharing, by the MT of the Reference IAB node, the configuration information of the DL-RS with the DU of the Reference IAB node, when the configuration information is provided to the MT of the Reference IAB by the Parent IAB node; and
receiving, by the DU of the Reference IAB node, a signal at a location of the DL-RS on an Uplink (UL) reception beam,
wherein the DU of the Reference IAB node measures interference in time-frequency resources where the DL-RS is scheduled.

2. The method as claimed in claim 1, wherein the trigger has a length of at least one bit.

3. The method as claimed in claim 1, wherein the measurement of interference includes at least one of a Reference Signal Receive Power (RSRP), Received Signal Strength Indicator (RSSI), and Reference Signal Received Quality (RSRQ).

4. The method as claimed in claim 1, wherein the configuration information of the DL-RS includes at least one of a time location of RS and frequency location of RS, RS sequence, RS precoder, and RS transmit power.

5. The method as claimed in claim 1, wherein no transmission in the UL is scheduled by the Reference IAB node for the Child IAB node, in the time-frequency resources where DL-RS is scheduled, to enable accurate measurement of the interference.

6. A method of interference measurement for power management in an integrated access and backhaul (IAB) network, the method comprising:
requesting, by one of a Mobile Termination (MT) of a Reference IAB node and a Distributed Unit (DU) of the Reference IAB node, to one of:
a Parent IAB node, for configuration of a Downlink (DL) signal and a DL signal transmission power, for measurement of pathloss, and
a Donor IAB node, for instructing a Parent IAB node for configuration of a DL signal and a DL signal transmission power for measurement of pathloss;
signalling, by the Parent IAB node, a configuration information of the DL signal for the measurement of pathloss,
receiving, by the Reference IAB node, the configuration information of the DL signal;
estimating, by the Reference IAB node, a pathloss between a DL transmission beam of the DU of the Parent IAB node and an Uplink (UL) reception beam of the DU of the Reference IAB node, based on DL signal transmit power information available at the Reference IAB node;
measuring, by the Reference IAB node, a gain of the UL reception beam at the DU of the Reference IAB node in the direction of a DL beam of the Parent IAB node; and
determining, by the Reference IAB node, a threshold value of receiver gain of UL reception beam based on at least one of a maximum tolerable interference power, measured pathloss, and DL transmission power from the Parent IAB node,
wherein comparison of a value of measured gain with a threshold gain of UL reception beam is utilized for determining level of interference caused by DL reception from the Parent IAB node on the UL reception from the Child IAB node.

7. The method as claimed in claim 6, wherein the DL signal is one of a Downlink Reference Signal (DL-RS), Synchronization Signal Block (SSB), DL data channel, or control channel.

8. The method as claimed in claim 6, wherein the configuration information includes at least one of a time locations, frequency locations, RS sequence, RS transmit power, channel content and channel average power.

9. The method as claimed in claim 6, wherein estimation of pathloss is done by one of the MT of the Reference IAB node for intra panel scenario and the DU of the Reference IAB node for inter panel scenario.

10. The method as claimed in claim 6, wherein the direction of the DL beam of the Parent IAB node is provided by the MT of the Reference IAB node to the DU of the Reference IAB node.

11. The method as claimed in claim 6, wherein the maximum tolerable interference power at the DU of the Reference IAB node is derived using UL target received power of the access link.

12. The method as claimed in claim 6, wherein the value of measured gain greater than the threshold gain of the UL reception beam indicates significant interference in the UL reception beam and the value of measured gain less than the threshold gain of the UL reception beam indicates negligible interference in the UL reception beam.

13. A method of interference measurement for power management in an integrated access and backhaul (IAB) network, the method comprising:
sending, by a Reference IAB node, a power ratios authentication request in one of Uplink Control Information (UCI) and Uplink (UL) data, to a Parent IAB node;
signaling, to the Parent IAB node, at least one of:
start time of simultaneous operation in Backhaul (BH) link in Downlink (DL) and Access (AC) link in UL of the Reference IAB node, by one of a Donor node and a Mobile Termination (MT) of the Reference IAB node, and
a number of symbols (N) present between a symbol where authentication request is sent and a first symbol of simultaneous operation by the Reference IAB node;
determining, by the Parent IAB node, if there is a change in power of at least one of a first Downlink (DL) signal, a first DL channel, and associated power ratios at a Distributed Unit (DU) of the Parent IAB node which causes a corresponding change in power of one of current and upcoming channels linked to at least one of the first DL signal and the first DL channel; and
performing, by the Parent IAB node, one of:
sending an authentication indicator to the MT of the Reference IAB node, if the same power ratios will be used for the DL transmissions at DU of the Parent IAB node, and
informing value of new power ratios to the MT of the Reference IAB node, if there is a change in the power ratios of DL transmissions at DU of the Parent IAB node,
wherein the Reference IAB node measures interference caused by BH-DL reception of at least one of the DL signal, and the DL channel at AC-UL reception using power ratios and at least one of power of Channel State Information Reference Signal (CSI-RS) and power of Synchronization Signal Block (SSB) configured to the MT of the Reference IAB node.

14. The method as claimed in claim 13, wherein the power ratios includes ratio of power of at least one of DL data, DL control, DL signal, and channel power to one of the CSI-RS and the SSB.

15. The method as claimed in claim 13, wherein the new power ratios are shared through at least one of Radio Resource Control (RRC), Medium Access Control-Control Element (MAC-CE), and Downlink Control Information (DCI).

16. The method as claimed in claim 13, wherein value of the number of symbols (N) ranges between a maximum and a minimum value, and wherein the maximum value is duration between the last symbol of downlink control information transmitted at a DU of the Reference IAB node for scheduling UL transmission at the MT of the Child IAB node and the start time of simultaneous operation at the Reference IAB node, and the minimum value is processing time required by the Reference IAB node for the simultaneous operation.

17. The method as claimed in claim 16, wherein the processing time required by the Reference IAB node is based on at least one of MT Physical Downlink Control Channel (PDCCH) decoding, Physical Data Shared Channel (PDSCH) reception preparation time, and DU scheduling time for the Child IAB node.

18. A method of interference measurement for power management in an integrated access and backhaul (IAB) network, the method comprising:
measuring, by a Reference IAB node, an interference power using at least one of a Downlink Reference Signal (DL-RS), Synchronization Signal Block (SSB), Downlink (DL) data channel, and control channel, from Parent IAB node; and
reporting, by the Reference IAB node, an assistant information of resources where interference occurred, to one of the Parent IAB node and a Donor node,
wherein the Parent IAB node performs DL power control in the reported resources.

19. The method as claimed in claim 18, wherein when the interference is measured, the Reference IAB node calculates a Signal to Interference and Noise Ratio (SINR) and derives a corresponding value of at least one of Channel Quality Indicator (CQI) and Modulation and Coding Scheme (MCS).

20. The method as claimed in claim 19, wherein the assistant information of resources is reported when at least one of a calculated value of the CQI is less than a target CQI value and the interference from a DL beam from the Parent IAB node is significant at Reference IAB node.

21. The method as claimed in claim 18, wherein the DL power control is performed by performing at least one of:
informing, by a Distributed Unit (DU) of the Reference IAB node, an interference power to the Mobile Termination (MT) of the Reference IAB node, and signalling, by the MT of the Reference IAB node, an indication of increase in the interference to the Parent IAB node; and
informing, by the DU of the Reference IAB node, an indication of increase in interference, to the Donor IAB node and requesting the Donor IAB node to configure DL power reduction at the Parent IAB node.

22. The method as claimed in claim 21, wherein the Parent IAB node receives a signal for the DL power control, from any one of:
the MT of the Reference IAB node, by including an additional indication of increase in interference in Uplink (UL),
the Donor IAB node, and
the DU of the Reference IAB node, through at least one of a new signal and channel.

23. The method as claimed in claim 22, wherein the method further comprises:
checking, by the Parent IAB node, for a change in beam pair;
performing, by the Parent IAB node, one of:
modification in DL power based on the increase in interference when there is no change in beam pair, and
calculation of new DL power for a newly latched beam pair, when there is a change in beam pair, and
indicating, by the Parent IAB node, newly latched beam pair index to the Reference IAB node through at least one of Downlink Control Information (DCI) and Medium Access Control-Control Element (MAC-CE) signalling.

24. The method as claimed in claim 18, wherein the signalling is performed using at least one of physical layer signalling, MAC-CE signalling, and Radio Resource Control (RRC) signalling.

25. A method of power management in an integrated access and backhaul (IAB) network, the method comprising:
configuring, by a Parent IAB node, a Reference IAB node with Downlink Reference Signal (DL-RS) for interference measurement and to feedback value of Downlink (DL) channel quality;
receiving, by the Parent IAB node, at least one of an indication of interference and the value of DL channel quality;
comparing, by the Parent IAB node, the value of DL channel quality with a target DL channel quality value;
assessing, by the Parent IAB node, fulfilment of the request for DL power reduction, wherein if the reported DL channel quality is lower than the target DL channel quality value, the request for DL power reduction cannot be fulfilled and the Reference IAB node switches to Time Domain Multiplexing (TDM) mode; and
performing, by the Parent IAB node, when the reported DL channel quality is higher than the target DL channel quality, one of:
reduction of the DL power for a time duration,
performing link adaptations techniques for reduction of DL power, and
indicating, by the Parent IAB node, a command for adjustment of received beam gain of the Uplink (UL) reception beam in a direction of the Parent IAB node to the Reference IAB node.

26. The method as claimed in claim 25, wherein the assessment of fulfilment of the request for DL power reduction includes assessment of a target Downlink Modulation and Coding Scheme (DL-MCS) being not affected by the reduction in DL power and a power of at least one of Synchronization Signal Block (SSB) and Channel State Information Reference Signal (CSI-RS) not being compromised.

27. The method as claimed in claim 25, wherein the link adaptation techniques include at least one of reducing Modulation and Coding Scheme (MCS), and reducing number of spatial layers.

28. The method as claimed in claim 25, further comprises, indicating by the Parent IAB node, an adapted change for reduction of the DL power for the time duration to the Reference IAB node through one of downlink control information (DCI) and Medium Access Control-Control Element (MAC-CE) signalling.

29. The method as claimed in claim 25, wherein the method further comprises:
monitoring, by the Parent IAB node, for expiration of a timer associated with an allotted time duration with reduced DL power, and upon expiry of the timer, using at least one of:
a conventional DL power defined for New Radio (NR) systems, and
a last updated DL power, based on an indication received from the Reference IAB node within the timer duration to use the last modified DL power.

30. The method as claimed in claim 29, further comprising, waiting by the Parent IAB node for a next DL power reduction request until expiry of the timer, and using modified DL power after assessment of the request for a further DL power reduction.

31. A method of power management in an integrated access and backhaul (IAB) network, the method comprising:
detecting, by a Reference IAB node, interference caused by the Downlink (DL) reception from a Parent IAB node on Uplink (UL) reception from at least one of a Child IAB node and an access link in any one of Frequency Division Multiplexing (FDM) and Space Division Multiplexing (SDM) modes; and
sending, by the Reference IAB node, a request for reduction in DL power by an offset to the Parent IAB node;
decreasing, by the Parent IAB node, the DL power based on the request for DL power reduction; and
acknowledging, by the Parent IAB node, by indicating the reduction in DL power to the Reference IAB node for the request for reduction in DL power.

32. The method as claimed in claim 31, wherein the request for reduction in DL power is in the form of a transmit power control (TPC) request, wherein the TPC request is one of existing format of TPC offset values described in New Radio (NR) for UL, one bit indication, a new offset value and a range of TPC values with a number of levels.

33. The method as claimed in claim 32, wherein the Parent IAB node determines a range of negative TPC values starting from zero to a negative minimum value depending on a target Modulation and Coding Scheme (MCS) and minimum transmit power of the Distributed Unit (DU) of the Parent IAB node with a defined step size.

34. The method as claimed in claim 31 through claim 33, wherein the decrement in DL power by the parent IAB node is in form of a defined step size within the range of negative TPC values and is decreased until a last value of TPC in the range is reached.

35. The method as claimed in claim 31, wherein the Parent IAB node monitors a timer for expiration of a time duration after receiving the TPC request for the decrement in DL power.

36. The method as claimed in claim 35, wherein the Parent IAB node uses one of a conventional DL power as defined for New Radio (NR) systems, and a modified DL power based on the received TPC request, when an indication from the Reference IAB node to use the modified DL power is received within the timer duration, when the timer expires.

37. The method as claimed in claim 35, wherein the Parent IAB node waits for next TPC request, until expiry of the timer.

38. The method as claimed in claim 31, wherein the request for DL power reduction is sent using at least one of User Control Information (UCI) signalling, Medium Access Control (MAC) signalling, and along with UL data.

39. A method of power management in an integrated access and backhaul (IAB) network, the method comprising:
detecting, by a Reference IAB node, an interference occurring in resources used for Uplink (UL) reception in access link by adjacent resources used for the Backhaul (BH) Downlink (DL) reception when the Reference IAB node uses Frequency Division Multiplexing (FDM) for the reception;
receiving, by the Parent IAB node, one of a request for reduction in DL power and associated resources from the Reference IAB node and instruction by the Donor IAB node for the reduction in DL power and associated resources; and
reducing, by the Parent IAB node, a DL transmission power to the received resources.

40. The method as claimed in claim 39, wherein the resources for the request of reduction in DL power are edge Resource Blocks (RBs) of bandwidth part allocated to an Mobile Termination (MT) of the Reference IAB node, wherein with the reduction in DL power by the Parent IAB node, the interference at adjacent Uplink (UL) reception at Distributed Unit (DU) of Reference IAB node is minimized and the edge RBs are utilized.

41. The method as claimed in claim 39, wherein the MT of the Reference IAB node sends the request for reduction in power of associated resources by including one bit signal in any of an Uplink control information (UCI) and Medium Access Control (MAC).

42. The method as claimed in claim 39, wherein the Parent IAB node reduces the DL transmission power for the edge RBs by using at least one of transmitting power equal to half of power in center RBs, transmitting power equal to UL power of adjacent RBs used for reception from access link at the DU of the Reference IAB node, transmitting less power consuming signals in the edge RBs, power control in the edge RBs utilizing a decrement in power offset received from the Reference IAB node in UCI and minimum power required for at least one of Synchronisation Signal Block (SSB) and Channel Status Information Reference Signal (CSI-RS).

43. A method of power management in an integrated access and backhaul (IAB) network, the method comprising:
determining, by a Parent IAB node, an initial minimum Downlink (DL) target power;
configuring and triggering, by the Parent IAB node, the resources for measurement and feedback of information of pathloss and a link quality;
reporting, by a Reference IAB node, a parameter indicating a Downlink Pathloss and the link quality measurement, to the Parent IAB node; and
determining, by the Parent IAB node, a DL transmission power of the link to the Reference IAB node based on at least one of the parameter indicating the Downlink Pathloss, the link quality measurement, and minimum DL target power.

44. The method as claimed in claim 43, wherein the initial minimum DL target power is equal to an uplink (UL) target power scaled with an offset, wherein the offset is dependent on at least modulation and coding scheme (MCS) used by the Parent IAB node.

45. The method as claimed in claim 43, wherein the DL transmission power of the link to the Reference IAB node is determined by adding at least one of a value of the Downlink Pathloss and an offset determined by the Parent IAB node based on the received link quality measurement report to the minimum DL target power.

46. The method as claimed in claim 43, wherein the parameter indicating the Downlink Pathloss and link quality measurement signalling is reported using at least one of physical layer signalling, Medium Access Control-Control Element (MAC-CE) signalling, and Radio Resource Control (RRC) signalling.

47. A method of power management in an integrated access and backhaul (IAB) network, the method comprising:
transmitting, by a Reference IAB node, an indication of requirement of increase in Backhaul Uplink (BH-UL) power beyond desired UL power decided by UL power control parameters, to a Parent IAB node;
sending, by the Parent IAB node, Transmit Power Control (TPC) commands with increased step size for the BH-UL from the Reference IAB node to reduce the number of TPC signalling for increase in UL transmit power;
signalling, by the Parent IAB node, an initial threshold UL transmit power to the Reference IAB node;
monitoring, by the Reference IAB node, receipt of the TPC command; and
increasing, by the Reference IAB node, the UL transmit power with the defined step size upon receiving every TPC command, when the UL transmit power is less than the threshold UL power.

48. The method as claimed in claim 47, wherein the Reference IAB node transmits with power equal to previous UL transmission power to the parent IAB node, when no TPC command is received.

49. The method as claimed in claim 47, wherein the Reference IAB node:
compares the UL transmit power with the threshold UL power when the TPC command is received, and
stops the increase of UL power when the UL transmit power is more than or equal to the threshold UL power.

50. The method as claimed in claim 47, wherein the signalling between Parent IAB node and Reference IAB node is performed using at least one of Radio Resource Control (RRC) signalling, Medium Access Control-Control Element (MAC-CE) signalling, and physical layer signalling.

51. The method as claimed in claim 47, wherein initial value for the threshold UL transmit power is determined using at least one of channel condition of network, and DL power spectral density.

52. The method as claimed in claim 47, wherein the threshold UL transmit power is less than or equal to maximum available power at the Reference IAB node.

53. The method as claimed in claim 47, wherein the method further comprises:
receiving, by the Parent IAB node, an information of interference caused to other ongoing transmission by the increased UL transmit power of Reference IAB node from at least one of a Donor node and a victim IAB node, wherein the information of interference is received by the Donor IAB node from the victim IAB node; and
reassigning, by the Parent IAB node, a new value for the threshold power equal to the UL transmit power at the instant of interference based on information from at least one of the Donor IAB node and the victim IAB node.

54. A method of power management in an integrated access and backhaul (IAB) network, the method comprising:
detection, by a Reference IAB node, power constraint when the Reference IAB node is using single panel for transmitting uplink (UL) and downlink (DL) traffic in both backhaul link and access link in any of Space Division Multiplexing (SDM) mode and Frequency Division Multiplexing (FDM) mode;
allotting, by an Mobile Termination (MT) of the Reference IAB node, an UL transmit power based on a UL power control indication from a Parent IAB node;
receiving, by the Reference IAB node, an indication of required DL transmit power using a UL control channel from a Child IAB node;
computing, by the Reference IAB node, a DL transmit power based on at least one of the indication of required DL transmit power, the target throughput, Bit Error Rate, total remaining available power, and a parameter for Pathloss to the Child IAB node;
computing, by the Reference IAB node, the DL transmit power to the access link; and
allocating, by the Reference IAB node, a remaining power to one of backhaul link to the Parent IAB node and one of access link to the user and backhaul link to the Child IAB node, based on load.

55. The method as claimed in claim 54, wherein the indication for required DL transmit power is one of an absolute power value, and is present as increments or decrements in existing power values.

56. The method as claimed in claim 54, wherein the parameter for Pathloss to the Child IAB node indicates DL Pathloss of backhaul link to the Child IAB node, wherein the DL Pathloss is considered as equal to UL Pathloss of the link measured by the Reference IAB node, based on reciprocity.

57. The method as claimed in claim 54, wherein the Reference IAB node computes the DL transmit power to the access links to users based on at least one of achievement of five percentile performance at required distance at a cell edge, power requirement of cell specific signals including at least one of Synchronization Signal Block (SSB), Channel State Information Reference Signal (CSI-RS), and the power available after allocation of UL transmit power to Parent IAB node and DL transmit power to Child IAB node.

58. The method as claimed in claim 54, wherein the Reference IAB node shares total available power for DL access link equally among various DL channels in the access link.
